(19) United States
(12) Patent Application Publication
(10) Pub. No.: US 2019/0248119 A1
(43) Pub. Date: Aug. 15, 2019

(54) PHOSPHOR-CONTAINING FILM AND BACKLIGHT UNIT

(71) Applicant: FUJIFILM Corporation, Tokyo (JP)

(72) Inventors: Takashi YONEMOTO, Kanagawa (JP); Natsuru CHIKUSHI, Kanagawa (JP)

(73) Assignee: FUJIFILM Corporation, Tokyo (JP)

(21) Appl. No.: 16/394,684

(22) Filed: Apr. 25, 2019

Related U.S. Application Data
(63) Continuation of application No. PCT/JP2017/039930, filed on Nov. 6, 2017.

(30) Foreign Application Priority Data
Nov. 7, 2016 (JP) 2016-216961
Nov. 30, 2016 (JP) 2016-232787

(51) Int. Cl. B32B 27/20; G02F 1/13357; B32B 27/06; B32B 3/30; C09K 11/02

(52) U.S. Cl. CPC B32B 27/20; G02F 1/1336; G02F 2001/133614; B32B 3/30; C09K 11/02; B32B 27/06

(57) ABSTRACT

A phosphor-containing film capable of suppressing the deterioration of the phosphor and suitable for production using a roll-to-roll method; and a backlight unit provided with the phosphor-containing film. The phosphor-containing film includes, between two facing substrate films, a first resin layer having a first concavo-convex shape on one main surface; a second resin layer having a second concavo-convex shape on the other main surface facing the one main surface of the first resin layer that has the first concavo-convex shape; and a third layer that follows the first concavo-convex shape and the second concavo-convex shape between the first resin layer and the second resin layer, in which the two substrate films are each a barrier film including a support film and a barrier layer laminated on the support film, the first resin layer and the second resin layer contain phosphors, and the third layer is formed of an inorganic material.

### CROSS-REFERENCE TO RELATED APPLICATIONS

This application is a Continuation of PCT International Application No. PCT/JP2017/039930 filed on Nov. 6, 2017, which claims priority under 35 U.S.C. § 119(a) to Japanese Patent Application No. 2016-216961, filed on Nov. 7, 2016 and Japanese Patent Application No. 2016-232787, filed on Nov. 30, 2016. Each of the above applications is hereby expressly incorporated by reference, in its entirety, into the present application.

### BACKGROUND OF THE INVENTION

### 1. Field of the Invention

The present invention relates to a phosphor-containing film containing phosphors that emit fluorescence upon irradiation with excitation light and a backlight unit comprising the phosphor-containing film as a wavelength conversion member.

### 2. Description of the Related Art

Applications of a flat panel display such as a liquid crystal display (LCD) as a space-saving image display device with low power consumption have been widespread year by year. In recent liquid crystal displays, further power saving, an enhancement in color reproducibility, or the like is required as an improvement in LCD performance.

Along with power saving of LCD backlight, in order to increase the light utilization efficiency and improve the color reproducibility, it has been proposed to use a wavelength conversion layer containing a quantum dot (QD, also referred to as a quantum point) that converts a wavelength of an incidence ray and emits the wavelength-converted light, as a luminescent material (phosphor).

The quantum dot has a state of an electron whose movement direction is restricted in all directions three-dimensionally. In a case where nanoparticles of a semiconductor are three-dimensionally surrounded by a high potential barrier, the nanoparticles become quantum dots. The quantum dot expresses various quantum effects. For example, a “quantum size effect” is expressed in which a density of electronic states (energy level) is discretized. According to this quantum size effect, the absorption wavelength and luminescence wavelength of light can be controlled by changing the size of a quantum dot.

Generally, such quantum dots are dispersed in a resin or the like, and used as a quantum dot film for wavelength conversion, for example, by being disposed between a backlight and a liquid crystal panel.

In a case where excitation light is incident from a backlight to a film containing quantum dots, the quantum dots are excited to emit fluorescence. Here, white light can be realized by using quantum dots having different luminescence properties and causing each quantum dot to emit light having a narrow half-width of red light, green light, or blue light.

Since the fluorescence by the quantum dot has a narrow half-width, wavelengths can be properly selected to thereby allow the resulting white light to be designed so that the white light is high in luminance and excellent in color reproducibility.

Meanwhile, there are problems that quantum dots are susceptible to deterioration due to moisture or oxygen, and particularly the luminescence intensity thereof decreases due to a photooxidation reaction. Therefore, the wavelength conversion member is configured in such a manner that gas barrier films are laminated on both main surfaces of a resin layer containing quantum dots (hereinafter, also referred to as a “quantum dot layer”) which is a wavelength conversion layer containing quantum dots, thereby protecting the quantum dot layer.

However, merely protecting both main surfaces of the quantum dot layer with gas barrier films has a problem in which moisture or oxygen enters from the end face not protected by the gas barrier film, and therefore the quantum dots deteriorate.

Therefore, it has been proposed to protect the entire periphery of the quantum dot layer with a barrier film.

For example, JP2010-061098A discloses a quantum point wavelength converting structure including a wavelength converting portion containing quantum points for wavelength-converting excitation light to generate wavelength-converted light and a dispersion medium for dispersing the quantum points, and a sealing member for sealing the wavelength converting portion, in which the wavelength converting portion is disposed between two sealing sheets which are sealing members, and the peripheries of the wavelength converting portion in the sealing sheets are heated and thermally adhered to each other, thereby sealing the wavelength converting portion.

Further, JP2009-283441A discloses a light emitting device comprising a color conversion layer (phosphor layer) for converting at least a part of color light emitted from a light source portion into another color light and a water impermeable sealing sheet for sealing the color conversion layer, and discloses a color conversion sheet (phosphor sheet) in which penetration of water into the color conversion layer is prevented by a configuration where the sheet has a second bonding layer provided in a frame shape along the outer periphery of the phosphor layer, that is, so as to surround the planar shape of the color conversion layer, and the second bonding layer is formed of an adhesive material having water vapor barrier properties.

### SUMMARY OF THE INVENTION

Meanwhile, the wavelength conversion layer containing quantum dots used for LCDs is a thin film of about 50 μm to 350 μm in thickness. There are problems that it is extremely difficult to coat the whole surface of such a very thin film with a sealing sheet such as a gas barrier film, thereby leading to poor productivity.

Such problems occur not only in quantum dots, but also in a phosphor-containing film comprising a phosphor which reacts with oxygen and deteriorates.

On the other hand, in order to produce a phosphor-containing film containing a phosphor such as a quantum dot with high production efficiency, preferred is a method of sequentially carrying out a coating step and a curing step on a long film by a roll-to-roll method to form a laminated structure and then cutting the resulting structure to a desired size.

However, in a case of obtaining a phosphor-containing film of a desired size by cutting from this long film, the phosphor-containing layer is again exposed to the outside air at the cut end face, so it is necessary to take measures against entry of oxygen from the cut end face.

The present invention has been made in view of the above circumstances and an object of the present invention is to provide a phosphor-containing film which is capable of suppressing the deterioration of a phosphor in a film containing the phosphor such as a quantum dot and is also suitable for production using a roll-to-roll method. Another object of the present invention is to provide a backlight unit comprising a phosphor-containing film with reduced luminance deterioration as a wavelength conversion member.

It was found that deterioration in luminance at an end portion of a phosphor-containing film is suppressed by a configuration that the phosphor-containing film of the present invention includes, between two facing substrate films, a first resin layer having a first concavo-convex shape on one main surface, a second resin layer having a second concavo-convex shape on the other main surface facing the one main surface of the first resin layer that has the first concavo-convex shape, and a third layer that follows the first concavo-convex shape and the second concavo-convex shape between the first resin layer and the second resin layer, the two substrate films are each a barrier film in which a barrier layer is laminated on a support film, the first resin layer and the second resin layer contain phosphors, and the third layer is formed of an inorganic material. The present invention has been completed based on these findings.

That is, it was found that the foregoing objects can be achieved by the following constitution.

(1) A phosphor-containing film comprising: between two facing substrate films,

a first resin layer having a first concavo-convex shape on one main surface;

a second resin layer having a second concavo-convex shape on the other main surface facing the one main surface of the first resin layer that has the first concavo-convex shape; and

a third layer that follows the first concavo-convex shape and the second concavo-convex shape between the first resin layer and the second resin layer,

in which the two substrate films are each a barrier film in which a barrier layer is laminated on a support film,

the first resin layer and the second resin layer contain phosphors, and

the third layer is formed of an inorganic material.

(2) The phosphor-containing film according to (1), in which the first resin layer and the second resin layer each contain different phosphors.

(3) The phosphor-containing film according to (1) or (2),

in which the first resin layer and the second resin layer each has a depth h of a concave portion of 10 μm or more and 150 μm or less, and

the third layer has a thickness t3 of 0.1 μm or more and 10 μm or less.

(4) The phosphor-containing film according to any one of (1) to (3), in which the third layer has an oxygen permeability of 10 cc/(m²·day·atm) or less.

(5) The phosphor-containing film according to any one of (1) to (4), in which the two substrate films each have an oxygen permeability of 1 cc/(m²·day·atm) or less.

(6) A backlight unit comprising:

the phosphor-containing film according to any one of (1) to (5) as a wavelength conversion member.

Since the phosphor-containing film of the present invention includes, between two facing substrate films, a first resin layer having a first concavo-convex shape on one main surface; a second resin layer having a second concavo-convex shape on the other main surface facing the one main surface of the first resin layer that has the first concavo-convex shape; and a third layer that follows the first concavo-convex shape and the second concavo-convex shape between the first resin layer and the second resin layer, in which the two substrate films are each a barrier film in which a barrier layer is laminated on a support film, the first resin layer and the second resin layer contain phosphors, and the third layer is formed of an inorganic material, penetration of oxygen and moisture in the film surface direction from the film end face to the region containing the phosphor can be effectively suppressed.

Since the phosphor-containing film of the present invention is suitable for a production method by a roll-to-roll method, and in a case where a phosphor-containing film of a desired size is produced by cutting a long film, the penetration of oxygen from the cut end face to the inside region containing phosphors is effectively suppressed, there is no need to perform another scaling treatment or the like for end faces at the time of cutting, whereby it is possible to further improve the production efficiency.

### BRIEF DESCRIPTION OF THE DRAWINGS

FIG. 1 is a cross-sectional view schematically showing an example of a phosphor-containing film of the present invention.

FIG. 2 is a plan view of the phosphor-containing film shown in FIG. 1.

FIG. 3 is a perspective view of the phosphor-containing film shown in FIG. 1.

FIG. 4 is a view for explaining a depth h of a concave portion in a fluorescent region and a width t between adjacent fluorescent regions.

FIG. 5 is a plan view of another example of the phosphor-containing film.

FIG. 6 is a schematic view for explaining a method for producing a phosphor-containing film.

FIG. 7 is a cross-sectional view of a schematic configuration of a backlight unit comprising a phosphor-containing film as a wavelength conversion member.

### DESCRIPTION OF THE PREFERRED EMBODIMENTS

Hereinafter, embodiments of a phosphor-containing film and a backlight unit comprising the phosphor-containing film according to the present invention will be described with reference to the accompanying drawings. In the drawings of the present specification, the scale of each part is appropriately changed for easy visual recognition. In the present specification, the numerical range expressed by using “to” means a range including numerical values described before and after “to” as a lower limit value and an upper limit value, respectively.

Further, in the present specification, the term “(meth)acrylate” refers to at least one or any one of acrylate or methacrylate. The same applies to “(meth)acryloyl” and the like.

In the present specification, a gas barrier means having impermeability to a gas, and a water vapor barrier means having impermeability to water vapor. Further, a layer having impermeability to both of oxygen and water vapor is referred to as a “barrier layer”.

<Phosphor-Containing Film>

The phosphor-containing film according to the embodiment of the present invention is a phosphor-containing film including: between two facing substrate films, a first resin layer having a first concavo-convex shape on one main surface; a second resin layer having a second concavo-convex shape facing the main surface of the first resin layer that has the first concavo-convex shape; and a third layer that follows the first concavo-convex shape and the second concavo-convex shape between the first resin layer and the second resin layer, in which the two substrate films are each a barrier film in which a barrier layer is laminated on a support film, the first resin layer and the second resin layer contain phosphors, and the third layer is formed of an inorganic material.

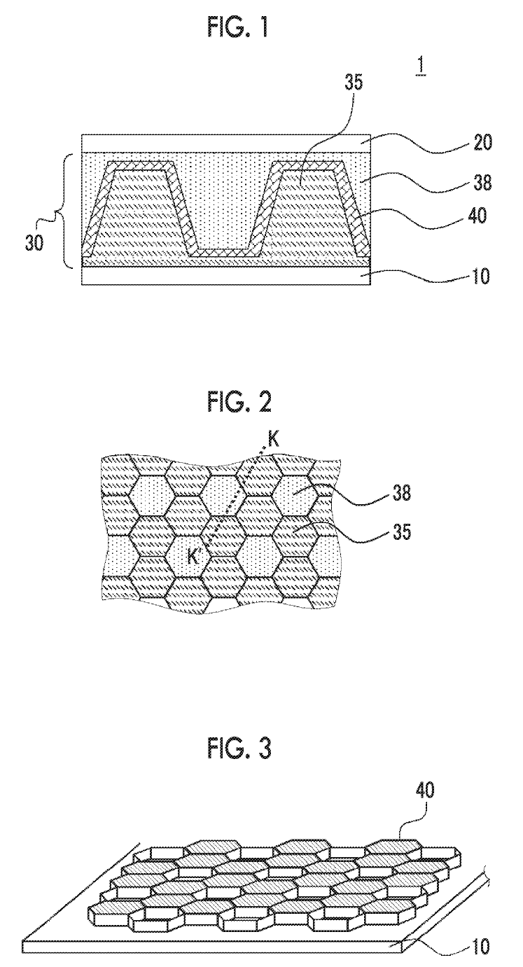

FIG. 1 is a cross-sectional view (a cross-sectional view taken along a line K-K′ in FIG. 2) schematically showing an example of a phosphor-containing film 1 according to the embodiment of the present invention, FIG. 2 is a plan view of FIG. 1, and FIG. 3 is a perspective view of FIG. 1.

For the sake of explanation, only a first fluorescent region and a second fluorescent region in plan view are shown in FIG. 2, and the illustration of a second substrate film 20 and the second fluorescent region is omitted in FIG. 3.

The phosphor-containing film 1 shown in FIG. 1 has a structure in which a first substrate film 10, a phosphor-containing layer 30, and a second substrate film 20 are laminated in this order.

The phosphor-containing layer 30 has a first fluorescent region 35, a second fluorescent region 38, and a third layer 40 laminated between the first fluorescent region 35 and the second fluorescent region 38.

The first fluorescent region 35 is a first resin layer in the present invention and contains a phosphor. In addition, the second fluorescent region 38 is a second resin layer in the present invention and contains a phosphor.

As shown in FIG. 1, each of the first fluorescent region 35 and the second fluorescent region 38 has a concavo-convex shape on one main surface, and the surface on which the concavo-convex shape of the first fluorescent region 35 (first concavo-convex shape) is formed and the surface on which the concavo-convex shape of the second fluorescent region 38 (second concavo-convex shape) is formed are arranged to face each other so that the first concavo-convex shape of the first fluorescent region 35 and the second concavo-convex shape of the second fluorescent region 38 are fitted to each other. That is, in the planar direction (plan view), the concave portion of the first fluorescent region 35 coincides in position with the convex portion of the second fluorescent region 38, and the convex portion of the first fluorescent region 35 coincides in position with the concave portion of the second fluorescent region 38.

Further, as shown in FIG. 1, the third layer is formed between the first fluorescent region 35 and the second fluorescent region 38, in a shape following the fitting portion between the first concavo-convex shape and the second concavo-convex shape. This third layer is formed of an inorganic material and has gas barrier properties.

Here, as shown in FIGS. 2 and 3, the first concavo-convex shape of the first fluorescent region 35 in plan view of the phosphor-containing film 1 has a shape in which a plurality of regular hexagonal concave portions and convex portions are arrayed in the closest packing. Specifically, a plurality of concave portions and convex portions are formed in a pattern in which six convex portions are disposed around one concave portion. Grooves are formed between the adjacent convex portions and therefore the convex portions are spaced apart from each other. A third layer is also formed in the groove.

In addition, the second concavo-convex shape of the second fluorescent region 38 has a shape in which a plurality of regular hexagonal concave portions and convex portions are arrayed in the closest packing, and has a shape in which the positions of the concave portion and the convex portion are interchanged from the first concavo-convex shape. Specifically, a plurality of concave portions and convex portions are formed in a pattern in which six concave portions are disposed around one convex portion.

The first concavo-convex shape and the second concavo-convex shape having such a shape are stacked with the positions of the one concave portion and the other convex portion coinciding with each other in the planar direction. Therefore, as shown in FIG. 2, the convex portion of the first concavo-convex shape and the convex portion of the second concavo-convex shape are disposed in the closest packing, and a third layer is formed between the convex portions.

As described above, the phosphor-containing film 1 has, between the first substrate film 10 and the second substrate film 20, a first resin layer having a first concavo-convex shape on one main surface, a second resin layer having a second concavo-convex shape on a main surface facing the main surface of the first resin layer that has the first concavo-convex shape, a third layer which follows the first concavo-convex shape and the second concavo-convex shape between the first resin layer and the second resin layer, the first resin layer and the second resin layer contain phosphors, and the third layer is formed of an inorganic material.

In the phosphor-containing film 1 according to the embodiment of the present invention, since the fluorescent regions, that is, the first fluorescent region 35 and the second fluorescent region 38 are discretely disposed in the two-dimensional direction through the third layer, assuming that the phosphor-containing film 1 is a part of a long film, whichever portion is linearly cut, the fluorescent region other than the fluorescent region which is the cut point is surrounded by the third layer, and thus can be kept in a sealed state. In addition, the fluorescent region that has been cut and exposed to outside air loses its function as an original phosphor, but the deactivated fluorescent region becomes a layer that protects the fluorescent region not exposed to outside air from the outside air.

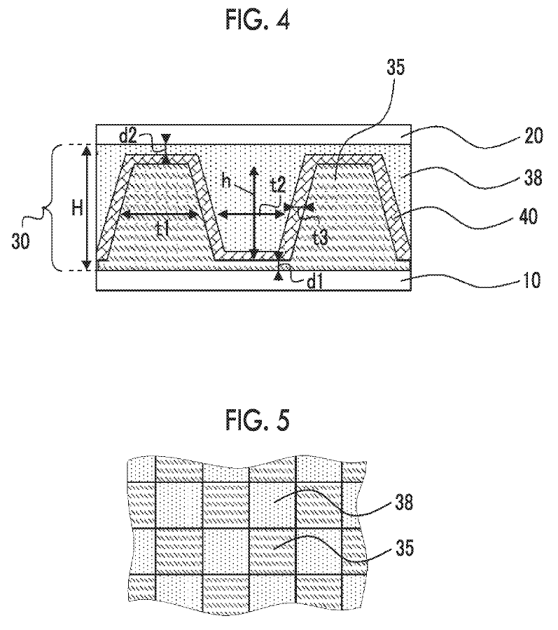

In the phosphor-containing film according to the embodiment of the present invention, as shown in FIG. 4, assuming that the depth of the concave portion of the first fluorescent region 35 where the second fluorescent region 38 is disposed is h, the depth h is preferably 1 μm or more and 150 μm or less.

In addition, the size (width) t1 of the convex portion of the first fluorescent region 35 and the size (width) t2 of the convex portion of the second fluorescent region 38 may be optionally set, but in one aspect, the size (width) t1 of the convex portion of the first fluorescent region 35 is 5 μm or more and 1000 μm or less, and the size (width) t2 of the convex portion of the second fluorescent region 38 is 5 μm or more and 1000 μm or less.

The width t1 and the width t2 are the width at the depth position of h/2, where h is the depth of the concave portion of the first fluorescent region 35.

As described above, in order to produce a phosphor-containing film containing a phosphor such as a quantum dot with high production efficiency, preferred is a method in which a coating step and a curing step are sequentially carried out on a long film by a roll-to-roll method to form a laminated structure which is then cut into a desired size. In a case where a phosphor-containing film of a desired size is cut from this long film, the phosphor-containing layer is exposed to the outside air at the cut end face, so it is necessary to take measures against the penetration of oxygen from the cut end face.

Then, by taking a configuration having first resin layer having a concavo-convex shape, a second resin layer having an concavo-convcx shape, and a third layer following the concavo-convex shape between the first resin layer and the second resin layer,

in which the first resin layer and the second resin layer contain phosphors and the third layer is formed of an inorganic material, in a case where cutting is made at a portion immediately adjacent to the third layer at the time of cutting the phosphor-containing film, it is possible to maximize the region where the fluorescent member is kept sealed even in a case of cutting an optical component and minimize the fluorescent region exposed to the outside air. That is, the effective area can be maximized.

in the phosphor-containing film according to the embodiment of the present invention, the third layer follows the concavo-convex shape formed by the first resin layer and the second resin layer. By virtue of its shape, the third layer following the concavo-convex shape seals all or a part of the thickness direction of the phosphor-containing layer 30, so that the amount of penetration of oxygen from the end portion of the film can be reduced and end portion deterioration can be suppressed. Clearances d1 and d2 (see FIG. 4) between the third layer and the surface of the two substrate films having barrier properties on the phosphor-containing layer side are preferably less than 10 μm, more preferably less than 5 μm, still more preferably less than 2 μm, and even more preferably less than 0.5 μm.

Although the target chromaticity can be reached in a case where the height (film thickness) H of the phosphor-containing layer 30 is 1 μm or more, it is preferable to have a film thickness of a certain level or more since the effect of the film thickness unevenness on the tint becomes large. On the other hand, in a case where the film thickness of the fluorescent region is too large, the amount of light absorption increases and therefore the initial luminance may decrease. From these viewpoints, the height H of the phosphor-containing layer 30 is 1 μm or more and 150 μm or less, preferably 5 μm or more and 80 μm or less, and more preferably 10 μm or more and 50 μm or less.

The width t3 of the third layer is preferably made thin from the viewpoint of obtaining a thin phosphor-containing film. On the other hand, from the viewpoint of strength and durability, a width of a certain level or more is required. From these viewpoints, the width t3 of the third layer is 0.1 μm or more and 10 μm or less, preferably 0.5 μm or more and 5 μm or less, and more preferably 0.5 μm or more and 2 μm or less.

The depth h of the concave portion formed in the first fluorescent region is determined in such a manner that a portion of the concave portion of the phosphor-containing film is cut with a microtome to form a cross section; the phosphor-containing layer is irradiated with excitation light to cause the phosphor to emit light; in this state, this cross section is observed with a confocal laser microscope; and ten concave portions are extracted and the depth thereof is measured and the measured values are averaged.

The width t1 of the convex portion of the first fluorescent region 35 and the width t2 of the convex portion of the second fluorescent region 38 are each determined in such a manner that a portion of the convex portion of the phosphor-containing film is cut with a microtome to form a cross section; the phosphor-containing layer is irradiated with excitation light to cause the phosphor to emit light; in this state, this cross section is observed with a confocal laser microscope; and ten convex portions are extracted and the width thereof is measured and the measured values are averaged.

The width t3 of the third layer is determined in such a manner that the phosphor-containing film is cut with a microtome to form a cross section, the cross section is observed with a scanning electron microscope, and ten places are measured and the measured values are averaged.

Clearances d1 and d2 between the third layer and the surface of the two substrate films having barrier properties on the phosphor-containing layer side are determined in such a manner that the phosphor-containing film is cut with a microtome to form a cross section, the cross section is observed with a scanning electron microscope, and 10 places in total with clearance d1 with the first substrate film at 5 places and clearance d2 with the second substrate film at 5 places are measured and the measured values are averaged.

Here, the first fluorescent region 35 is a first resin layer in which a phosphor 31 is dispersed in a binder 33. The second fluorescent region 38 is a second resin layer in which a phosphor 36 is dispersed in a binder 39.

In a case where the oxygen permeability of the binder 33 and the binder 39 is larger than that of the third layer, that is, in a case where the first resin layer and the second resin layer are readily permeable to oxygen, the effects of the present invention are particularly significant.

In addition, the first substrate film 10 and the second substrate film 20 are impermeable to oxygen. Each of the first substrate film 10 and the second substrate film 20 is a barrier film having a laminated structure of a support film (11, 21) and a barrier layer (12, 22) having impermeability to oxygen.

In addition, the size and arrangement pattern of the fluorescent regions, that is, the first fluorescent region 35 and the second fluorescent region 38 are not particularly limited and may be appropriately designed according to desired conditions. In designing, geometric constraints for arranging the fluorescent regions spaced apart from each other in plan view, allowable values of the width of the non-light emitting region generated at the time of cutting, and the like are taken into consideration. Further, for example, in a case where the printing method is used as one of the methods for forming a fluorescent region to be described later, there is also a restriction that printing cannot be carried out unless the individual occupied area (in plan view) is not less than a certain size. Furthermore, the shortest distance between adjacent fluorescent regions is required to be a distance capable of achieving an oxygen permeability of the third layer of 10 cc/(m-day-atm) or less. In consideration of these factors, desired shape, size, and arrangement pattern may be designed.

In the above embodiment, the convex portion and the concave portion of the fluorescent region are in a regular hexagonal columnar shape and is regular hexagonal in plan view, but the shape of the fluorescent region is not particularly limited. As shown in FIG. 5, the convex portion and the concave portion may be square in plan view. Alternatively, the convex portion of the fluorescent region may be a polygonal prism or a regular polygonal prism. In the above example, the bottom surface of the polygonal prism is disposed in parallel to the substrate film surface, but the bottom surface may not necessarily be disposed parallel to the substrate film surface. The shape of each fluorescent region may be amorphous. The shape of each fluorescent region may not be the same.

In order to obtain a sufficient amount of fluorescence, it is desirable to make the fluorescent region in the phosphor-containing layer 30 as large as possible.

The area ratio of the first fluorescent region 35 and the second fluorescent region 38 can be freely set. For example, in a case where the luminescence wavelengths of the first phosphor contained in the first fluorescent region and the second phosphor contained in the second fluorescent region 38 are different from each other, it is preferable to adjust so that the backlight turns white. Adjustment of the white point can be made not only by the area ratio of the fluorescent region but also by the concentration of the phosphor in the coating liquid.

The phosphor 31 in the first fluorescent region 35 may be of one type or of plural types.

Likewise, the phosphor 36 in the second fluorescent region 38 may be of one type or of plural types.

In one aspect, the first phosphor 31 in the first fluorescent region 35 and the second phosphor 36 in the second fluorescent region 38 have different luminescence center wavelengths. For example, it is possible to use a phosphor having a luminescence center wavelength in the wavelength range of 520 to 560 nm as the first phosphor 31 and a phosphor having a luminescence center wavelength in the wavelength range of 600 to 680 nm as the second phosphor 36.

In particular, in a case where at least one different type of phosphor is used for the first fluorescent region and the second fluorescent region, the effects of the present invention significantly appear.

The effects will be described in detail below.

Apart from deterioration of the phosphor due to oxygen or moisture from the outside, deterioration of the phosphor may occur due to decomposition of the phosphor itself in response to heating, detachment of a ligand adsorbed on the phosphor, or the like. In addition, a decomposed substance generated upon deterioration of the phosphor or a detached ligand may affect different types of phosphors to accelerate deterioration thereof in some cases.

In a case where two or more types of phosphors having different structures are used as the phosphor, for example, in a case where an inorganic phosphor such as a rare earth doped garnet, a silicate, an aluminate, a phosphate, a ceramic phosphor, a sulfide phosphor, a nitride phosphor, an oxynitride phosphor, or a fluoride phosphor and a quantum dot are used in combination, a decomposed substance generated at the time of deterioration of the quantum dot, a detached ligand, or the like may deteriorate the inorganic phosphor in some cases.

In addition, even in a case where two types of quantum dots are used as the phosphor, deterioration of the phosphor may occur in some cases. More specifically, since the ligands suitable for each quantum dot are different, there is a case that one of the ligands adsorbs to the other quantum dot, thereby deteriorating the luminescence properties. For example, in a case where a quantum dot using an amine compound as a ligand and a quantum dot containing a carboxylic acid compound or a phosphorus compound as a ligand are combined, the detached ligands adsorb to the quantum dots of each other and therefore deteriorate luminescence properties. For commercially available quantum dots, octadecylamine as a ligand was used for CdSe/ZnS (manufactured by NN-labs, LLC., Sigma-Aldrich Co. LLC.), octadecylphosphonic acid as a ligand was used for CdTe (manufactured by NN-labs, LLC.), and oleylamine and a phosphorus-based compound (structure not disclosed) as a ligand were used for InP/ZnS (manufactured by NN-labs, LLC.). In a case where these quantum dots are combined to prepare a wavelength conversion member which is then heated, it is possible to confirm significant deterioration of luminescence properties.

As a result of extensive studies, the present inventors have found that, in a case where a third layer made of an inorganic material is provided between the first fluorescent region and the second fluorescent region, it is possible to prevent decomposed substances generated upon deterioration of the phosphor or detached ligands from penetrating into the other layer containing different types of phosphors, thereby suppressing deterioration in luminance after a heating test.

Individual constituent elements of the phosphor-containing film according to the embodiment of the present invention will be described below.

The phosphor-containing film 1 has a configuration comprising the first substrate film 10 and the second substrate film 20, in which the phosphor-containing layer 30 is sandwiched between the two substrate films 10 and 20.

—Phosphor-Containing Layer—

The phosphor-containing layer 30 includes a fluorescent region and a third layer formed of an inorganic material, and the fluorescent region comprises the first fluorescent region 35 and the second fluorescent region 38.

<<Region Containing Phosphor (Fluorescent Region)>>

The phosphor-containing film according to the embodiment of the present invention comprises the first fluorescent region 35 and the second fluorescent region 38 as fluorescent regions.

The first fluorescent region 35 includes the phosphor 31 and the binder 33 in which the phosphor 31 is dispersed. The first fluorescent region 35 is formed by applying and curing a coating liquid 32 for forming a fluorescent region containing the phosphor 31 and a curable compound.

The second fluorescent region 38 includes the phosphor 36 and the binder 39 in which the phosphor 36 is dispersed. The second fluorescent region 38 is formed by applying and curing a coating liquid 37 for forming a fluorescent region containing the phosphor 36 and a curable compound.

<Phosphor>

Various known phosphors can be used as a phosphor which deteriorates by being reacted with oxygen upon exposure to oxygen. Examples of the phosphor include inorganic phosphors such as a rare earth doped garnet, a silicate, an aluminate, a phosphate, a ceramic phosphor, a sulfide phosphor, a nitride phosphor, an oxynitride phosphor, and a fluoride phosphor; and organic fluorescent materials including an organic fluorescent dye and an organic fluorescent pigment. In addition, phosphors with rare earth-doped semiconductor fine particles, and semiconductor nanoparticles (quantum dots and quantum rods) are also preferably used. A single kind of phosphor may be used alone, but a plurality of phosphors having different wavelengths may be mixed and used so as to obtain a desired fluorescence spectrum, or a combination of phosphors of different material constitutions (for example, a combination of a rare earth doped garnet and quantum dots) may be used.

As used herein, the phrase “exposure to oxygen” means exposure to an environment containing oxygen, such as in the atmosphere, and the phrase “deteriorates by being reacted with oxygen” means that the phosphor is oxidized so that the performance of the phosphor deteriorates (decreases) and refers to mainly the luminescence performance declining as compared with that before the reaction with oxygen, and in a case where the phosphor is used as a photoelectric conversion element, such a phrase means that the photoelectric conversion efficiency declines as compared with that before the reaction with oxygen.

In the following description, as a phosphor deteriorating by oxygen, mainly quantum dots will be described as an example. However, the phosphor of the present invention is not limited to quantum dots and is not particularly limited as long as it is a fluorescent coloring agent that deteriorates due to oxygen, or a material that converts energy from the outside into light or converts light into electricity, such as a photoelectric conversion material.

Apart from deterioration due to oxygen, depending on the structure of the phosphor, deterioration of the phosphor may occur due to decomposition of the phosphor itself in response to heating or the like and detachment of a ligand adsorbed to the phosphor.

(Quantum Dot)

The quantum dot is a fine particle of a compound semiconductor having a size of several nm to several tens of nm and is at least excited by incident excitation light to emit fluorescence.

The phosphor of the present embodiment may include at least one quantum dot or may include two or more quantum dots having different luminescence properties. Known quantum dots include a quantum dot (A) having a luminescence center wavelength in a wavelength range of 600 nm or more and 680 nm or less, a quantum dot (B) having a luminescence center wavelength in a wavelength range of 500 nm or more to less than 600 nm, and a quantum dot (C) having a luminescence center wavelength in a wavelength range of 400 nm or more to less than 500 nm, and the quantum dot (A) is excited by excitation light to emit red light, the quantum dot (B) is excited by excitation light to emit green light, and the quantum dot (C) is excited by excitation light to emit blue light. For example, in a case where blue light is incident as excitation light to a phosphor-containing layer containing the quantum dot (A) and the quantum dot (B), red light emitted from the quantum dot (A), green light emitted from the quantum dot (B) and blue light penetrating through the phosphor-containing layer can realize white light. Alternatively, ultraviolet light can be incident as excitation light to a phosphor-containing layer containing the quantum dots (A), (B), and (C), thereby allowing red light emitted from the quantum dot (A), green light emitted from the quantum dot (B), and blue light emitted from the quantum dot (C) to realize white light.

With respect to the quantum dot, reference can be made to, for example, paragraphs [0060] to [0066] of JP2012-169271A, but the quantum dot is not limited to those described therein. As the quantum dot, commercially available products can be used without any limitation. The luminescence wavelength of the quantum dot can usually be adjusted by the composition and size of the particles.

The quantum dot can be added in an amount of, for example, about 0.1 to 10 parts by mass with respect to 100 parts by mass of the total amount of the coating liquid.

The quantum dots may be added into the coating liquid in the form of particles or in the form of a dispersion liquid in which the quantum dots are dispersed in an organic solvent. It is preferable that the quantum dots be added in the form of a dispersion liquid, from the viewpoint of suppressing aggregation of quantum dot particles. The organic solvent used for dispersing the quantum dots is not particularly limited.

As the quantum dots, for example, core-shell type semiconductor nanoparticles are preferable from the viewpoint of improving durability. As the core, Group II-VI semiconductor nanoparticles, Group III-V semiconductor nanoparticles, multi-component semiconductor nanoparticles, and the like can be used. Specific examples thereof include, but are not limited to, CdSe, CdTe, CdS, ZnS, ZnSe, ZnTe, InP, InAs, and InGaP. Among them, CdSe, CdTe, InP, InGaP are preferable from the viewpoint of emitting visible light with high efficiency. As the shell, CdS, ZnS, ZnO, GaAs, and complexes thereof can be used, but it is not limited thereto. The luminescence wavelength of the quantum dot can usually be adjusted by the composition and size of the particles.

The quantum dot may be a spherical particle or may be a rod-like particle also called a quantum rod, or may be a tetrapod-type particle. A spherical quantum dot or rod-like quantum dot (that is, a quantum rod) is preferable from the viewpoint of narrowing a full width at half maximum (FWHM) and enlarging the color reproduction range of a liquid crystal display.

In the present invention, in a case where two or more types of quantum dots having different configurations or compositions are used, it is preferable to divide the region into a first fluorescent region and a second fluorescent region, respectively. In addition, in a case where one or more types of quantum dots are used in combination with phosphors other than quantum dots, it is preferable to divide the region into a first fluorescent region and a second fluorescent region, respectively. Division of the region makes it possible to select different binders or use different types of additives, so that dispersibility and stability of the phosphor in the binder are improved, and it is possible to provide a phosphor-containing film having excellent durability. In addition, by providing the third layer of the present invention, it is possible to prevent decomposed substances of the phosphor itself and ligands detached from the phosphor from penetrating into the other fluorescent region, thereby suppressing deterioration in luminance.

<Curable Compound Constituting Binder of Fluorescent Region>

A compound having a polymerizable group can be widely adopted as the curable compound. The type of the polymerizable group is not particularly limited and is preferably a (meth)acrylate group, a vinyl group, or an epoxy group, more preferably a (meth)acrylate group, and still more preferably an acrylate group. With respect to a polymerizable monomer having two or more polymerizable groups, the respective polymerizable groups may be the same as or different from each other.

—(Meth)Acrylate-Based Compounds—

From the viewpoint of transparency, adhesiveness, or the like of a cured film after curing, a (meth)acrylate compound such as a monofunctional or polyfunctional (meth)acrylate monomer, a polymer or prepolymer thereof, or the like is preferable. In the present invention and the present specification, the term “(meth)acrylate” is used to mean at least one or any one of acrylate or methacrylate. The same applies to the term “(ineth)acryloyl” and the like.

—Difunctional Ones—

The polymerizable monomer having two polymerizable groups may be, for example, a difunctional polymerizable unsaturated monomer having two ethylenically unsaturated bond-containing groups. The difunctional polymerizable unsaturated monomer is suitable for allowing a composition to have a low viscosity. In the present embodiment, preferred is a (meth)acrylate-based compound which is excellent in reactivity and which has no problems associated with a remaining catalyst and the like.

In particular, neopentyl glycol di(meth)acrylate, 1,9-nonanediol di(meth)acrylate, dipropylene glycol di(meth)acrylate, tripropylene glycol di(meth)acrylate, tetraethylene glycol di(meth)acrylate, hydroxypivalate neopentyl glycol di(meth)acrylate, polyethylene glycol di(meth)acrylate, dicyclopentenyl(meth)acrylate, dicyclopentenyl oxyethyl(meth)acrylate, dicyclopentanyl di(meth)acrylate, or the like is suitably used in the present invention.

The amount of the difunctional (meth)acrylate monomer to be used is preferably 5 parts by mass or more and more preferably 10 to 80 parts by mass with respect to 100 parts by mass of the total amount of the curable compound contained in the coating liquid, from the viewpoint of adjusting the viscosity of the coating liquid to a preferable range.

—Tri- or Higher Functional Ones—

The polymerizable monomer having three or more polymerizable groups may be, for example, a polyfunctional polymerizable unsaturated monomer having three or more ethylenically unsaturated bond-containing groups. Such a polyfunctional polymerizable unsaturated monomer is excellent in terms of imparting mechanical strength. In the present embodiment, preferred is a (meth)acrylate-based compound which is excellent in reactivity and which has no problems associated with a remaining catalyst and the like.

Specifically, epichlorohydrin (ECH)-modified glycerol tri(meth)acrylate, ethylene oxide (EO)-modified glycerol tri(meth)acrylate, propylene oxide (PO)-modified glycerol tri(meth)acrylate, pentaerythritol triacrylate, pentaerythritol tetraacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl)isocyanurate, dipentaerythritol hexa(meth)acrylate, dipentaerythritol penta(meth)acrylate, caprolactone-modified dipentaerythritol hexa(meth)acrylate, dipentaerythritol hydroxypenta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritolethoxy tetra(meth)acrylate, pentaerythritol tetra(meth)acrylate, or the like is suitable.

Among them, EO-modified glycerol tri(meth)acrylate, PO-modified glycerol tri(meth)acrylate, trimethylolpropane tri(meth)acrylate, EO-modified trimethylolpropane tri(meth)acrylate, PO-modified trimethylolpropane tri(meth)acrylate, dipentaerythritol hexa(meth)acrylate, dipentaerythritol penta(meth)acrylate, pentaerythritolethoxy tetra(meth)acrylate, or pentaerythritol tetra(meth)acrylate is particularly suitably used in the present invention.

The amount of the polyfunctional (meth)acrylate monomer to be used is preferably 5 parts by mass or more from the viewpoint of the coating film hardness of the fluorescent-containing layer after curing, and preferably 95 parts by mass or less from the viewpoint of suppressing gelation of the coating liquid, with respect to 100 parts by mass of the total amount of the curable compound contained in the coating liquid.

—Monofunctional Ones—

A monofunctional (meth)acrylate monomer may be, for example, acrylic acid or methacrylic acid, or derivatives thereof, more specifically, a monomer having one polymerizable unsaturated bond ((meth)acryloyl group) of (meth)acrylic acid in the molecule. Specific examples thereof include the following compounds, but the present embodiment is not limited thereto.

Examples thereof include alkyl (meth)acrylates having 1 to 30 carbon atoms in the alkyl group, such as methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, and stearyl (meth)acrylate; aralkyl (meth)acrylates having 7 to 20 carbon atoms in the aralkyl group, such as benzyl (meth)acrylate; alkoxyalkyl (meth)acrylates having 2 to 30 carbon atoms in the alkoxyalkyl group, such as butoxyethyl (meth)acrylate; aminoalkyl (meth)acrylates having 1 to 20 carbon atoms in total in the (monoalkyl or dialkyl)aminoalkyl group, such as N,N-dimethylaminoethyl (meth)acrylate; polyalkylene glycol alkyl ether (meth)acrylates having 1 to 10 carbon atoms in the alkylene chain and having 1 to 10 carbon atoms in the terminal alkyl ether, such as diethylene glycol ethyl ether (meth)acrylate, triethylene glycol butyl ether (meth)acrylate, tetraethylene glycol monomethyl ether (meth)acrylate, hexaethylene glycol monomethyl ether (meth)acrylate, octaethylene glycol monomethyl ether (meth)acrylate, nonaethylene glycol monomethyl ether (meth)acrylate, dipropylene glycol monomethyl ether (meth)acrylate, heptapropylene glycol monomethyl ether (meth)acrylate, and tetraethylene glycol monoethyl ether (meth)acrylate; polyalkylene glycol aryl ether (meth)acrylates having 1 to 30 carbon atoms in the alkylene chain and having 6 to 20 carbon atoms in the terminal aryl ether, such as hexaethylene glycol phenyl ether (meth)acrylate; (meth)acrylates having an alicyclic structure and having 4 to 30 carbon atoms in total, such as cyclohexyl (meth)acrylate, dicyclopentanyl (meth)acrylate, isobornyl (meth)acrylate, and methylene oxide addition cyclodecatriene (meth)acrylate; fluorinated alkyl (meth)acrylates having 4 to 30 carbon atoms in total, such as heptadecafluorodecyl (meth)acrylate; (meth)acrylates having a hydroxyl group, such as 2-hydroxyethyl (meth)acrylate, 3-hydroxypropyl (meth)acrylate, 4-hydroxybutyl (meth)acrylate, triethylene glycol mono(meth)acrylate, tetracthylenc glycol mono(meth)acrylate, hexaethylene glycol mono(meth)acrylate, octapropylene glycol mono(meth)acrylate, and glycerol mono or di(meth)acrylate; (meth)acrylates having a glycidyl group, such as glycidyl (meth)acrylate; polyethylene glycol mono(meth)acrylates having 1 to 30 carbon atoms in the alkylene chain, such as tetraethylene glycol mono(meth)acrylate, hexaethylene glycol mono(meth)acrylate, and octapropylene glycol mono(meth)acrylate; and (meth)acrylamides such as (meth)acrylamide, N,N-dimethyl (meth)acrylamide, N-isopropyl (meth)acrylamide, 2-hydroxyethyl (meth)acrylamide, and acryloylmorpholine.

The amount of the monofunctional (meth)acrylate monomer to be used is preferably 10 parts by mass or more and more preferably 10 to 80 parts by mass with respect to 100 parts by mass of the total amount of the curable compound contained in the coating liquid, from the viewpoint of adjusting the viscosity of the coating liquid to a preferable range.

—Epoxy-Based Compounds and Others—

The polymerizable monomer used in the present embodiment may be, for example, a compound having a cyclic group such as a ring-opening polymerizable cyclic ether group such as an epoxy group or an oxetanyl group. Such a compound may be more preferably, for example, a compound having a compound (epoxy compound) having an epoxy group. Use of the compound having an epoxy group or an oxetanyl group in combination with the (meth)acrylate-based compound tends to improve adhesiveness to the barrier layer.

Examples of the compound having an epoxy group include polyglycidyl esters of polybasic acids, polyglycidyl ethers of polyhydric alcohols, polyglycidyl ethers of polyoxyalkylene glycols, polyglycidyl ethers of aromatic polyols, hydrogenated compounds of polyglycidyl ethers of aromatic polyols, urethane polyepoxy compounds, and epoxidized polybutadienes. These compounds may be used alone or in admixture of two or more thereof.

Examples of other compounds having an epoxy group, which may be preferably used, include aliphatic cyclic epoxy compounds, bisphenol A diglycidyl ethers, bisphenol F diglycidyl ethers, bisphenol S diglycidyl ethers, brominated bisphenol A diglycidyl ethers, diglycidyl ethers, bisphenol S diglycidyl ethers, brominated bisphenol A diglycidyl ethers, brominated bisphenol F diglycidyl ethers, brominated bisphenol S diglycidyl ethers, hydrogenated bisphenol A diglycidyl ethers, hydrogenated bisphenol F diglycidyl ethers, hydrogenated bisphenol S diglycidyl ethers, 1,4-butanediol diglycidyl ethers, 1,6-hexanediol diglycidyl ethers, glycerin triglycidyl ethers, trimethylolpropane triglycidyl ethers, polyethylene glycol diglycidyl ethers, and polypropylene glycol diglycidyl ethers; polyglycidyl ethers of polyether polyols, obtained by adding one or two or more alkylene oxides to an aliphatic polyhydric alcohol such as ethylene glycol, propylene glycol, or glycerin; diglycidyl esters of aliphatic long chain dibasic acids; monoglycidyl ethers of aliphatic higher alcohols; monoglycidyl ethers of polyether alcohols, obtained by adding an alkylene oxide to phenol, cresol, butyl phenol, or these compounds; and glycidyl esters of higher fatty acids.

Among these components, aliphatic cyclic epoxy compounds, bisphenol A diglycidyl ethers, bisphenol F diglycidyl ethers, hydrogenated bisphenol A diglycidyl ethers, hydrogenated bisphenol F diglycidyl ethers, 1,4-butanediol diglycidyl ethers, 1,6-hexanediol diglycidyl ethers, glycerin triglycidyl ethers, trimethylolpropane triglycidyl ethers, neopentyl glycol diglycidyl ethers, polyethylene glycol diglycidyl ethers, and polypropylene glycol diglycidyl ethers are preferable.

Examples of commercially available products which can be suitably used as the compound having an epoxy group or an oxetanyl group include UVR-6216 (manufactured by Union Carbide Corporation), glycidol, AOEX24, CYCLOMER A200, CELLOXIDE 2021P and CELLOXIDE 8000 (all manufactured by Daicel Corporation), 4-vinylcyclohexene dioxide manufactured by Sigma-Aldrich Co. LLC.), EPIKOTE 828, EPIKOTE 812, EPIKOTE 1031, EPIKOTE 872 and EPIKOTE CT508 (all manufactured by Yuka Shell Epoxy K.K.), and KRM-2400, KRM-2410, KRM-2408, KRM-2490, KRM-2720 and KRM-2750 (all manufactured by Asahi Denka Kogyo K.K.). These compounds may be used alone or in combination of two or more thereof.

Although there are no particular restrictions on the production method of such a compound having an epoxy group or an oxetanyl group, the compound can be synthesized with reference to, for example, Literatures such as Fourth Edition Experimental Chemistry Course 20 Organic Synthesis II, from p. 213, 1992, published by Maruzen KK; Ed. by Alfred Hasfner, The chemistry of heterocyclic compounds-Small Ring Heterocycles part 3 Oxiranes, John & Wiley and Sons, An Interscience Publication, New York, 1985, Yoshimura, Adhesion, Vol. 29, No. 12, 32, 1985, Yoshimura, Adhesion, Vol. 30, No. 5, 42, 1986, Yoshimura, Adhesion, Vol. 30, No. 7, 42, 1986, JP1999-100378A (JP-H11-100378A), JP2906245B, and JP2926262B.

A vinyl ether compound may be used as the curable compound used in the present embodiment.

As the vinyl ether compound, a known vinyl ether compound can be appropriately selected, and, for example, the compound described in paragraph [0057] of JP2009-073078A may be preferably adopted.

Such a vinyl ether compound can be synthesized by, for example, the method described in Stephen. C. Lapin, Polymers Paint Colour Journal. 179 (4237), 321 (1988), namely, by a reaction of a polyhydric alcohol or a polyhydric phenol with acetylene, or a reaction of a polyhydric alcohol or a polyhydric phenol with a halogenated alkyl vinyl ether, and such method and reactions may be used alone or in combination of two or more thereof.

For the coating liquid of the present embodiment, a silsesquioxane compound having a reactive group described in JP2009-073078A can also be used from the viewpoint of a decrease in viscosity and an increase in hardness.

The curable compound forming the first fluorescent region 35 and the second fluorescent region 38 may be a cationically polymerizable compound or a radically polymerizable compound.

Preferred is a radically polymerizable curable composition in which the polymerizable compound is a radically polymerizable compound and the photopolymerization initiator is a radical polymerization initiator that generates radicals by photo-irradiation.

The curable compound forming the first fluorescent region 35 and the second fluorescent region 38 may contain a silane coupling agent. Since the adhesiveness to the adjacent third layer and barrier layer is strengthened by the silane coupling agent, even a hydrophobic monomer having poor adhesiveness can be used in the present invention. This is mainly due to the fact that the silane coupling agent contained in a wavelength conversion layer forms a covalent bond with the surface of the adjacent layer or the constituent component of the adjacent layer by a hydrolysis reaction or condensation reaction. Further, in a case where the silane coupling agent has a reactive functional group such as a radically polymerizable group, forming a crosslinked structure with the monomer component constituting the wavelength conversion layer can also contribute to improvement of adhesiveness between the wavelength conversion layer and the adjacent layer. As the silane coupling agent, a known silane coupling agent can be used without any limitation. From the viewpoint of adhesiveness, preferred silane coupling agents include silane coupling agents represented by General Formula (1) described in JP2013-043382A. For details thereof, reference can be made to the description in paragraphs [0011] to [0016] of JP2013-043382A. The amount of the additive such as the silane coupling agent to be used is not particularly limited and can be appropriately set.

(Other Components)

In addition to the above-mentioned components, the curable compound forming the first fluorescent region 35 and the second fluorescent region 38 may contain other components such as an antioxidant in accordance with various purposes as long as the effects of the present invention are not impaired.

—Antioxidant—

The curable compound forming the first fluorescent region 35 and the second fluorescent region 38 preferably contains a known antioxidant. The content of the antioxidant is, for example, 0.01 to 10% by mass and preferably 0.2 to 5% by mass, with respect to the total polymerizable monomers. In a case where two or more antioxidants are used, the total amount thereof falls within the above-specified range. The antioxidant is for preventing color fading by heat or photo-irradiation, and for preventing color fading by various oxidizing gases such as ozone, active oxygen NOx, and SOx (x is an integer).

Especially in the present invention, addition of the antioxidant brings about advantages that the cured film is prevented from being colored and the film thickness is prevented from being reduced through decomposition. Examples of the antioxidant include hydrazides, hindered amine-based antioxidants, nitrogen-containing heterocyclic mercapto compounds, thioether-based antioxidants, hindered phenol-based antioxidants, ascorbic acids, zinc sulfate, thiocyanates, thiourea derivatives, saccharides, nitrites, sulfites, thiosulfates, and hydroxylamine derivatives. Of those, hindered phenol-based antioxidants and thioether-based antioxidants are particularly preferable from the viewpoint of their effect of preventing cured film coloration and preventing film thickness reduction.

Examples of commercially available antioxidants include Irganox 1010, 1035, 1076 and 1222 (trade names, all manufactured by Ciba-Geigy AG); Antigene P, 3C, FR, SUMILIZER S, and SUMILIZER GA80 (trade names, all manufactured by Sumitomo Chemical Co., Ltd.); and ADEKASTAB A070, A080 and AO503 (trade names, all manufactured by Adeka Corporation). These compounds may be used alone or in admixture thereof.

—Polymerization Inhibitor—

The curable compound forming the first fluorescent region 35 and the second fluorescent region 38 preferably contains a polymerization inhibitor. The content of the polymerization inhibitor is 0.001% to 1% by mass, more preferably 0.005% to 0.5% by mass, and still more preferably 0.008% to 0.05% by mass, with respect to all the polymerizable monomers, and changes in viscosity over time can be suppressed while maintaining a high curing sensitivity by blending the polymerization inhibitor in an appropriate amount. The polymerization inhibitor may be added at the time of production of the polymerizable monomer or may be added later to the curable composition. Preferred examples of the polymerization inhibitor include hydroquinone, p-methoxyphenol, di-tert-butyl-p-cresol, pyrrogallol, tert-butylcatechol, benzoquinone, 4,4′-thiobis(3-methyl-6-tert-butylphenol), 2,2′-methylenebis(4-methyl-6-tert-butylphenol), cerous N-nitrosophenylhydroxyamine, phenothiazine, phenoxazine, 4-methoxynaphthol, 2,2,6,6-tetramethylpiperidine-1-oxyl free radical, 2,2,6,6-tetramethylpiperidine, 4-hydroxy-2,2,6,6-tetramethylpiperidine-1-oxyl free radical, nitrobenzene, and dimethylaniline, among which preferred is p-benzoquinone, 2,2,6,6-tetramethylpiperidine-1-oxyl free radical, 4-hydroxy-2,2,6,6-tetramethylpiperidine-1-oxyl free radical, or phenothiazine. These polymerization inhibitors suppress generation of polymer impurities not only during the production of the polymerizable monomers but also during storage of the curable composition and suppress degradation of pattern formability during imprinting.

Further, The curable compound forming the first fluorescent region 35 and the second fluorescent region 38 preferably contains inorganic particles. Incorporation of inorganic particles can provide an enhanced impermeability to oxygen. Examples of inorganic particles include inorganic layered compounds such as silica particles, alumina particles, zirconium oxide particles, zinc oxide particles, titanium oxide particles, mica, and talc. The inorganic particles are preferably plate-like from the viewpoint of enhancing the impermeability to oxygen, and the aspect ratio (r=a/b, where a>b) of the inorganic particles is preferably 2 or more and 1000 or less, more preferably 10 or more and 800 or less, and particularly preferably 20 or more and 500 or less. A larger aspect ratio is preferable because it has an excellent effect of enhancing the impermeability to oxygen. However, in a case where the aspect ratio is too large, physical strength of a film or particle dispersibility in a curing composition is poor.

In addition to the above-mentioned components, a releasing agent, a silane coupling agent, an ultraviolet absorber, a light stabilizer, an anti-aging agent, a plasticizer, an adhesion promoter, a thermal polymerization initiator, a colorant, elastomer particles, a photoacid proliferating agent, a photobase generator, a basic compound, a flow adjusting agent, an anti-foaming agent, a dispersant, or the like may be optionally added to the curable compound forming the first fluorescent region 35 and the second fluorescent region 38.

<<Third Layer>>

The third layer is made of an inorganic material and has a function of suppressing permeation of oxygen.

The inorganic material constituting the third layer is not particularly limited and, for example, a metal, or various inorganic compounds such as inorganic oxides, nitrides, and oxynitrides can be used. Elements constituting the inorganic material are preferably silicon, aluminum, magnesium, titanium, tin, indium, and cerium, and one or more of these elements may be contained. Specific examples of the inorganic compound include silicon oxide, silicon oxynitride, aluminum oxide, magnesium oxide, titanium oxide, tin oxide, indium oxide alloy, silicon nitride, aluminum nitride, and titanium nitride. A metal film such as an aluminum film, a silver film, a tin film, a chromium film, a nickel film, or a titanium film may be provided as the inorganic layer.

In particular, it is preferable to form a glass layer from an organosilane compound by a sol-gel method.

By forming the glass layer from the organosilane compound by the sol-gel method, it is possible to obtain the third layer in a shape following concavity and convexity without defects.

The organosilane compound is preferably polysilazane or an alkoxysilane compound represented by Formula (1). In particular, polysilazane is more preferable because it is easy to obtain high barrier properties since organic components do not remain after conversion into SiO₂.

R₄₋ₙSi(OR¹)ₙ (1)

(in the formula, R, R¹, and n are as defined above, R¹'s may be the same as or different from each other, and R's may be the same as or different from each other in a case where n is 2)

From the viewpoint of barrier properties, it is preferable that n=3 or 4 where high density can be expected.

Polysilazane is available as an adjusted commercially available product with a catalyst added, and the AQUAMICA series (manufactured by AZ Electronic Materials plc) can be used as it is as a stock solution or diluted with a solvent. Among the AQUAMICA series, more preferred are NPII0, NP140, SP140, and UP140 which are converted into SiO₂ at low temperature.

Examples of the organosilane compound (n=4) include tetraalkoxysilanes such as tetramethoxysilane, tetraethoxysilane, tetrapropoxysilane, and tetrabutoxysilane.

Examples of the organosilane compound (n=3) include trialkoxysilanes such as trimethoxysilane, triethoxysilane, and tripropoxysilane; monoalkyltrialkoxysilanes such as monomethyltrimethoxysilane, monomethyltriethoxysilane, monomethyltripropoxysilane, monoethyltrimethoxysilane, monoethyltriethoxysilane, monoethyltripropoxysilane, monopropyltrimethoxysilane, and monopropyltriethoxysilane; and monophenyltrialkoxysilanes such as monophenyltrimethoxysilane and monophenyltriethoxysilane.

Examples of the organosilane compound (n=2) include dialkoxysilanes such as dimethoxysilane, diethoxysilane, and dipropoxysilane; monoalkyldialkoxysilanes such as monomethyldimethoxysilane, monomethyldiethoxysilane, monomethyldipropoxysilane, monoethyldimethoxysilane, monoethyl diethoxysilane, monoethyldipropoxysilane, monopropyldimethoxysilane, monopropyldiethoxysilane, and monopropyldipropoxysilane; dialkyldialkoxysilane such as dimethyldimethoxysilane, dimethyldiethoxysilane, dimethyldipropoxysilane, diethyldimethoxy silane, diethyldiethoxysilane, diethyldipropoxysilane, dipropyldimethoxysilane, dipropyldiethoxysilane, and dipropyldipropoxysilane; and diphenyl dialkoxysilane such as diphenyldimethoxysilane and diphenyldiethoxysilane.

The third layer preferably satisfies an oxygen permeability of 10 cc/(m²·day·atm) or less at the shortest distance between the adjacent first fluorescent region 35 and second fluorescent region 38. The oxygen permeability at the shortest distance between the adjacent first fluorescent region 35 and the second fluorescent region 38 of the third layer is more preferably 1 cc/(m²·day·atm) or less and still more preferably 10⁻¹ cc/(m²·day·atm) or less. The necessary shortest distance varies depending on the composition of the third layer.

With respect to oxygen permeability, fm/(s·Pa) can be used as the SI unit. It is possible to carry out conversion of units as a relationship of 1 fm/(s·Pa)=8.752 cc/(m²·day·atm). fm is read as femtometer and 1 fm=10⁻¹⁵ m.

The necessary shortest distance between the first fluorescent region 35 and the second fluorescent region 38 varies depending on the composition of the third layer as described above, but as an example, the shortest distance between adjacent fluorescent regions 35 of the third layer, that is, the width of the third layer is preferably 0.001 mm or more and 3 mm or less, more preferably 0.01 mm or more and 2 mm or less, and particularly preferably 0.03 mm or more and 2 mm or less. In a case where the width of the third layer is too short, it is difficult to secure the necessary oxygen permeability, and in a case where the width of the third layer is too wide, luminance unevenness of a display device is deteriorated, which is not preferable.

—Substrate Film—

The substrate films 10 and 20 are each preferably a film having a function of suppressing permeation of oxygen. In the above-mentioned embodiment, the substrate films 10 and 20 each have a configuration which comprises the barrier layers 12 and 22 on one surface of the support films 11 and 21, respectively. In such an aspect, the presence of the support films 11 and 21 improves the strength of the phosphor-containing film and makes it possible to easily carry out film formation.

The substrate films 10 and 20 each have a total light transmittance in the visible light region of preferably 80% or more and more preferably 85% or more. The visible light region refers to a wavelength range of 380 to 780 nm, and the total light transmittance refers to an average value of light transmittances over the visible light region.

The oxygen permeability of each of the substrate films 10 and 20 is preferably 1.00 cc/(m²·day·atm) or less. The oxygen permeability is more preferably 0.1 cc/(m²·day·atm) or less, still more preferably 0.01 cc/(m²·day·atm) or less, and particularly preferably 0.001 cc/(m²·day·atm) or less. The oxygen permeability here is a value measured using an oxygen gas permeability measuring apparatus (OX-TRAN 2/20, trade name, manufactured by MOCON Inc.) under conditions of a measurement temperature of 23° C. and a relative humidity of 90%.

In addition to having a gas barrier function of blocking oxygen, the substrate films 10 and 20 preferably have a function of blocking moisture (water vapor). The moisture permeability (water vapor permeability) of the substrate films 10 and 20 is preferably 0.10 g/(m²·day·atm) or less and more preferably 0.01 g/(m²·day·atm) or less.

(Support Film)

The support films 11 and 21 are each preferably a flexible belt-like support which is transparent to visible light. The phrase “transparent to visible light” as used herein refers to a light transmittance in the visible light region of 80% or more and preferably 85% or more. The light transmittance for use as a measure of transparency can be calculated by the method described in JIS-K7105, namely, by measuring a total light transmittance and an amount of scattered light using an integrating sphere type light transmittance measuring apparatus, and subtracting the diffuse transmittance from the total light transmittance. With respect to the flexible support, reference can be made to paragraphs [0046] to [0052] of JP2007-290369A and paragraphs [0040] to [0055] of JP2005-096108A.

The support film preferably has barrier properties against oxygen and moisture. Preferred examples of such a support film include a polyethylene terephthalate film, a film made of a polymer having a cyclic olefin structure, and a polystyrene film.

From the viewpoint of gas barrier properties, impact resistance, and the like, the thickness of the support film is in a range of 10 to 500 μm, inter alia, preferably in a range of 15 to 300 μm, particularly preferably in a range of 15 to 120 μm, more particularly preferably in a range of 15 to 100 μm, further preferably 25 to 110 pun, and still further preferably 25 to 60 μm.

(Barrier Layer)

The barrier layers 12 and 22 are mainly layers that exhibit gas barrier properties.

The barrier layers 12 and 22 may include at least one inorganic layer and at least one organic layer. Lamination of a plurality of layers in this way is preferable from the viewpoint of improving the light resistance due to being capable of further more enhancing barrier properties. On the other hand, the light transmittance of the substrate film tends to decrease as the number of layers to be laminated is increased, and therefore it is desirable to increase the number of laminated layers as long as a satisfactory light transmittance can be maintained.

Specifically, the barrier layers 12 and 22 preferably have a total light transmittance in the visible light region of preferably 80% or more and an oxygen permeability of 1.00 cc/(m²·day·atm) or less.

The oxygen pcrmcability of the barrier layers 12 and 22 is more preferably 0.1 cc/(m²·day·atm) or less, particularly preferably 0.01 cc/(m²·day·atm) or less, and more particularly preferably 0.001 cc/(m²·day·atm) or less.

A lower oxygen permeability is more preferable, and a higher total light transmittance in the visible light region is more preferable.

The inorganic layer in the barrier layers 12 and 22 is a layer containing an inorganic material as a main component and is preferably a layer formed from only an inorganic material.

The inorganic layer in the barrier layer is preferably a layer having a gas barrier function of blocking oxygen. Specifically, the oxygen permeability of the inorganic layer is preferably 1.00 cc/(m²·day·atm) or less. The oxygen permeability of the inorganic layer can be determined by attaching a wavelength conversion layer to a detector of an oxygen concentration meter manufactured by Orbisphere Laboratories, via silicone grease, and then converting the oxygen permeability from the equilibrium oxygen concentration value. It is also preferable that the inorganic layer has a function of blocking water vapor.

Two or three or more inorganic layers in the barrier layer may also be included in the barrier layer.

The thickness of the inorganic layer in the substrate film may be 1 to 500 nm, and is preferably 5 to 300 nm and particularly preferably 10 to 150 nm. This is because the film thickness of the inorganic layer in the above range is capable of suppressing reflection on the inorganic layer while achieving satisfactory barrier properties, whereby a laminated film with higher light transmittance can be provided.

The inorganic material constituting the inorganic layer in the barrier layer is not particularly limited, and for example, a metal, or various inorganic compounds such as inorganic oxides, nitrides or oxynitrides can be used therefor. For elements constituting the inorganic material, silicon, aluminum, magnesium, titanium, tin, indium, and cerium are preferable, and these elements may be included singly or two or more thereof may be included.

Specific examples of the inorganic compound include silicon oxide, silicon oxynitride, aluminum oxide, magnesium oxide, titanium oxide, tin oxide, an indium oxide alloy, silicon nitride, aluminum nitride, and titanium nitride. As the inorganic layer, a metal film, for example, an aluminum film, a silver film, a tin film, a chromium film, a nickel film, or a titanium film may also be provided.

It is particularly preferable that the inorganic layer having barrier properties is an inorganic layer containing at least one compound selected from silicon nitride, silicon oxynitride, silicon oxide, or aluminum oxide, among the above-mentioned materials. This is because the inorganic layer formed of such a material is satisfactory in adhesiveness to the organic layer, and therefore, not only, even in a case where the inorganic layer has a pinhole, the organic layer can effectively fill in the pinhole to suppress fracture, but also, even in a case where the inorganic layer is laminated, an extremely satisfactory inorganic layer film can be formed to result in a further enhancement in barrier properties.

The organic layer in the barrier layer refers to a layer containing an organic material as a main component, in which the organic material preferably occupies 50% by mass or more, further preferably 80% by mass or more, and particularly preferably 90% by mass or more.

With respect to the organic layer in the barrier layer, reference can be made to paragraphs [0020] to [0042] of JP2007-290369A and paragraphs [0074] to [0105] of JP2005-096108A. It is preferable that the organic layer contains a cardo polymer within a range satisfying the above-mentioned adhesion force conditions. This is because adhesiveness to the layer adjacent to the organic layer, in particular, also adhesiveness to the inorganic layer can be thus improved to achieve excellent gas barrier properties. With respect to details of the cardo polymer, reference can be made to paragraphs [0085] to [0095] of JP2005-096108A described above. The film thickness of the organic layer is in a range of 0.05 to 10 μm, inter alia, preferably in a range of 0.5 to 10 μm. In a case where the organic layer is formed by a wet coating method, the film thickness of the organic layer is in a range of 0.5 to 10 μm, inter alia, preferably in a range of 1 to 5 μm. In a case where the organic layer is formed by a dry coating method, the film thickness of the organic layer is preferably in a range of 0.05 to 5 μm, inter alia, preferably in a range of 0.05 to 1 μm. This is because the film thickness of the organic layer formed by a wet coating method or a dry coating method in the above-specified range is capable of further improving adhesiveness to the inorganic layer.

With respect to other details of the inorganic layer and the organic layer in the barrier layer, reference can be made to the descriptions of JP2007-290369A and JP2005-096108A described above and US201210113672A1.

<Light Scattering Layer>

In one aspect, the substrate film can comprise a light scattering layer.

The light scattering layer is preferably provided on the surface of the substrate film which is not in contact with the phosphor-containing layer 30 of the support film. By providing the light scattering layer, the haze of the phosphor-containing film can be increased and light emission of the phosphor can be efficiently taken out. Therefore, a backlight with high luminance can be obtained in a case where a phosphor-containing film as a wavelength conversion member is incorporated into the backlight.

The thickness of the light scattering layer is preferably in a range of 1 to 15 μm, more preferably in a range of 1 to 10 μm, and still more preferably in a range of 1 to 6 μm, from the viewpoint of compatibility between light scattering properties and thinning of the light scattering layer.

The light scattering layer can be formed, for example, by applying the foregoing polymerizable composition on a suitable substrate, optionally drying the film thus formed to remove the solvent, and then polymerizing and curing the film by photo-irradiation, heating, or the like. For example, a substrate on which a wavelength conversion layer has already been formed or a substrate on which a wavelength conversion layer is formed after formation of a light scattering layer can be used as the substrate. Thus, a wavelength conversion member having a wavelength conversion layer and a light scattering layer can be obtained through a substrate or on a substrate. As a coating method, a variety of known coating methods described later regarding the formation of the wavelength conversion layer can be mentioned. The curing conditions can be appropriately set depending on the type of the polymerizable compound and the composition of the polymerizable composition which will be used.

(Light Scattering Particles)

The light scattering layer is a layer containing light scattering particles in a matrix. A particle size of the light scattering particles is 0.1 μm or more, and from the viewpoint of scattering effects, it is preferably in a range of 0.5 to 15.0 μm and more preferably in a range of 0.7 to 12.0 μm. In addition, in order to further improve luminance or to adjust luminance distribution with respect to a view angle, two or more types of light scattering particles having different particle sizes may be mixed and used. In a case where particles having a large particle size are referred to as particles having a large particle diameter, and particles having a particle size smaller than that of the particles having a large particle diameter are referred to as particles having a small particle diameter, the particle size of the particles having a large particle diameter is preferably in a range of 5.0 μm to 15.0 μm and more preferably in a range of 6.0 μm to 12.0 μm, from the viewpoint of imparting external scattering properties and anti-Newton ring properties. In addition, the particle size of the particles having a small particle diameter is preferably in a range of 0.5 μm to 5.0 μm and more preferably in a range of 0.7 μm to 3.0 μm, from the viewpoint of imparting internal scattering properties.

The light scattering particles may be organic particles, inorganic particles, or organic-inorganic composite particles. For example, synthetic resin particles can be used as the organic particles. Specific examples of the synthetic resin particles include silicone resin particles, acrylic resin particles (polymethyl methacrylate (PMMA)), nylon resin particles, styrene resin particles, polyethylene particles, urethane resin particles, and benzoguanamine particles, among which the silicone resin particles and the acrylic resin particles are preferable from the viewpoint of availability of particles having a suitable refractive index. In addition, particles having a hollow structure can also be used.

It is preferable that a refractive index difference between the light scattering particles and the matrix of the light scattering layer is large from the viewpoint of the scattering effects. From this point, a refractive index difference Δn between the light scattering particles and the matrix is preferably 0.02 or more, more preferably 0.10 or more, and still more preferably 0.20 or more. A refractive index of the light scattering particles is, for example, in a range of 1.40 to 1.45 and preferably in a range of 1.42 to 1.45. Here, the refractive index also refers to the average refractive index described above. Furthermore, the same applies to a “refractive index” described below.

The light scattering particles are contained in the light scattering layer at a volume fraction of preferably 10 volume % (vol %) to 70 vol % and more preferably 20 vol % to 60 vol %, from the viewpoint of light scattering properties of the light scattering layer and from the viewpoint of a brittleness of the light scattering layer.

(Matrix of Light Scattering Layer)

The method of forming the light scattering layer is not particularly limited, and it is preferable that the light scattering layer is formed as a cured layer of a polymerizable composition (a curable composition) containing the light scattering particles and a polymerizable compound, from the viewpoint of productivity or the like. A suitable polymerizable compound may be used as the polymerizable compound described above by being selected from commercially available products or polymerizable compounds synthesized by a known method, in consideration of a refractive index of a material forming the wavelength conversion layer so as to satisfy n1<n2. Examples of a preferred polymerizable compound include a compound having an ethylenically unsaturated bond on at least one of a terminal or a side chain, and/or a compound having an epoxy group or an oxetane group on at least one of a terminal or a side chain, among which the compound having an ethylenically unsaturated bond on at least one of a terminal or a side chain is more preferable. Specific examples of the compound having an ethylenically unsaturated bond on at least one of a terminal or a side chain include a (meth)acrylate-based compound, an acrylamide-based compound, a styrene-based compound, and a maleic acid anhydride, among which the (meth)acrylate-based compound is preferable, and the acrylate-based compound is more preferable. The (meth)acrylate-based compound is preferably, for example, (meth)acrylate, urethane (meth)acrylate, polyester (meth)acrylate, or epoxy (meth)acrylate. The styrene-based compound is preferably, for example, styrene, α-methyl styrene, 4-methyl styrene, divinyl benzene, 4-hydroxy styrene, or 4-carboxy styrene.

In addition, a compound having a fluorene skeleton is also preferably used as the acrylate-based compound. Specific examples of such a compound include compounds represented by Formula (2) described in WO20131047524A1.

Further, in order to adjust the refractive index of the matrix, particles having a particle size smaller than that of the light scattering particles can be used as refractive index adjusting particles. A particle size of the refractive index adjusting particles is less than 0.1 μm.

Examples of the refractive index adjusting particles include particles of diamond, titanium oxide, zirconium oxide, lead oxide, lead carbonate, zinc oxide, zinc sulfide, antimony oxide, silicon oxide, aluminum oxide, and the like. Among them, particles of zirconium oxide or silicon oxide are preferable from the viewpoint of little absorption of blue light or ultraviolet light, and particles of zirconium oxide are preferable from the viewpoint that a refractive index can be adjusted in a small amount. The refractive index adjusting particles may be used in an amount that allows adjustment of the refractive index, and the content of the refractive index adjusting particles in the light scattering layer is not particularly limited.

Further, one or more types of known additives such as a polymerization initiator and a surfactant, or one or more types of solvents for adjusting a viscosity or the like may also be added to the polymerizable composition for forming the light scattering layer in a certain amount. A known additive and a known solvent can be used without any limitation as the additive and the solvent.

<Method of Producing Phosphor-Containing Film>

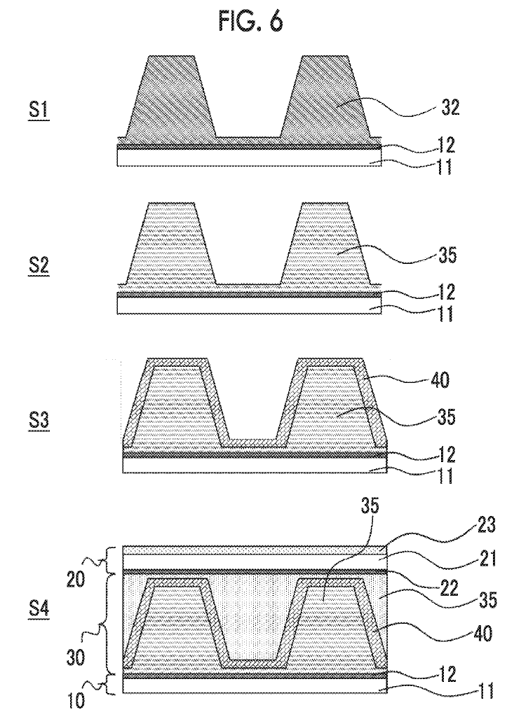

Next, an example of production steps of the phosphor-containing film 1 according to the embodiment of the present invention configured as described above will be described with reference to FIG. 6.

(Coating Liquid Preparation Step)

In the first coating liquid preparation step, a coating liquid for forming a first fluorescent region containing quantum dots (or quantum rods) as phosphors is prepared. Specifically, individual components such as quantum dots, a curable compound, a thixotropic agent, a polymerization initiator, and a silane coupling agent dispersed in an organic solvent are mixed in a tank or the like to prepare a coating liquid 32 for forming a first fluorescent region. Note that the coating liquid for forming a fluorescent region may not contain an organic solvent.

In the second coating liquid preparation step, a coating liquid 37 for forming a second fluorescent region is prepared by the same procedure as the first coating liquid preparation step.

In the third coating liquid preparation step, a coating liquid containing an inorganic material is prepared.

(First Fluorescent Region Forming Step)

Next, predetermined pattern printing is carried out on the barrier layer 12 of the first substrate film 10 using the coating liquid 32 for forming a first fluorescent region (S1), and the solvent is evaporated as necessary, so that the coating liquid 32 for forming a first fluorescent region is cured to form a first fluorescent region 35 (S2).

(Third Layer Forming Step)

The third layer coating liquid 37 is applied to the surface of the first fluorescent region 35 and then cured (S3). Thereby, the third layer 40 having impermeability to oxygen is formed.

Then, the coating liquid 37 for forming a second fluorescent region is applied and filled on the third layer of the concave portion of the first fluorescent region 35.

Before curing the coating liquid 37 for forming a second fluorescent region after application thereof, a coating film coated with the coating liquid 37 wound around a backup roller and being transported and a second substrate film wound around a lamination roller and being transported are sandwiched and nipped between the lamination roller and the backup roller to carry out a lamination step of laminating the second substrate film on the coating film side of the coating film, and then the coating liquid 37 is cured, whereby the phosphor-containing film of the embodiment can be produced (S4).

Through the above steps, the phosphor-containing film 1 of the embodiment can be produced.

It should be noted that the first fluorescent region forming step and the second fluorescent region forming step may be reversed.

(Cutting Process)

A continuous (long) phosphor-containing film can be obtained by carrying out the foregoing steps in a roll-to-roll type apparatus. The obtained phosphor-containing film is cut (cut) by a cutting machine if necessary.

Here, a method of forming a concavo-convex pattern in the first fluorescent region forming step will be described.

In the formation of a pattern, it is possible to use a so-called photoimprint method in which a fine concavo-convex pattern is formed through a step of applying the coating liquid 32 for forming a first fluorescent region on a substrate film, a step of pressing a mold against the surface of the coating layer, a step of irradiating the coating film with light, and a step of peeling the mold.

Here, the coating liquid 32 for forming a first fluorescent region may be poured between the substrate film and the mold, and then photocured while pressing the mold under pressure. Further, it may be further heated and cured after photo-irradiation. Such photoimprint lithography can also be used for lamination or multiple patterning and can be used in combination with thermal imprint.

Pattern formation can also be carried out by an inkjet method or a dispenser method.

Hereinafter, the concavo-convex pattern forming method (pattern transfer method) will be specifically described.

First, the coating liquid 32 for forming a first fluorescent region is applied onto a substrate film. The methods of applying the coating liquid 32 onto the substrate include commonly well-known application methods such as dip coating, air knife coating, curtain coating, wire bar coating, gravure coating, extrusion coating, spin coating, slit scanning, casting, and ink jet methods, by which a coating film or liquid droplets may be applied onto the substrate film. The coating liquid 32 for forming a first fluorescent region is suitable for a gravure coating method and a casting method. The film thickness of a pattern forming layer (coating layer for forming a pattern) formed of the coating film of the coating liquid 32 varies depending on the application to be used, but it is about 1 to 150 μm. Alternatively, the coating liquid 32 may be coated by multiple coating. Further, another organic layer such as a planarizing layer may be formed between the substrate film and the pattern forming layer. Thus, since the pattern forming layer and the substrate film are not in direct contact with each other, adhesion of dust to the substrate film, damage of the substrate film, and the like can be prevented.

Next, in order to transfer the pattern to the pattern forming layer, the mold is pressed onto the surface of the pattern forming layer. In this way, a fine pattern preliminarily formed on the surface, to be pressed, of the mold may be transferred to the pattern forming layer. Alternatively, a curable compound may be applied onto a mold having a pattern formed thereon, and the substrate may be pressed thereto. For photoimprint lithography, a light-transmissive material is selected for at least one of the mold material and/or the substrate. In the photoimprint lithography, a curable compound is applied onto a substrate to form a pattern forming layer thereon, and a light-transmissive mold is pressed against the surface of the pattern forming layer, then this is irradiated with light from the back of the mold, and the curable compound is thereby cured. Alternatively, a curable compound is applied onto a light-transmissive substrate, then a mold is pressed against the surface of the coating layer, and this is irradiated with light from the back of the substrate whereby the curable compound can be cured.

The photo-irradiation may be carried out in a state in which the mold is attached or after the mold is released, but it is preferable to perform photo-irradiation in a state where the mold is closely attached.

The mold usable herein is a mold having formed thereon a pattern to be transferred. The pattern on the mold may be formed according to desired processing accuracy, for example, by photolithography, electron beam lithography, or the like, but the method of forming a mold pattern is not particularly limited.

The light-transmissive mold material is not particularly limited, but any material having predetermined strength and durability may be used. Specific examples thereof include glass, quartz, a light-transparent resin such as PMMA or polycarbonate resin, a transparent metal vapor-deposited film, a flexible film made of polydimethylsiloxane or the like, a photocured film, and a metal film such as SUS.

On the other hand, the non-light-transmissive mold material is not particularly limited, but any material having a predetermined strength may be used. Specific examples of the mold material include a ceramic material, a vapor deposited film, a magnetic film, a reflective film, a metal substrate such as Ni, Cu, Cr, Fe, or the like, and a substrate of SiC, silicon, silicon nitride, polysilicon, silicon oxide, amorphous silicon, or the like. Further, the shape of the mold is not particularly limited, either a plate-like mold or a roll-like mold may be used. The roll-like mold is applied particularly in a case where continuous productivity of transfer is required.

A mold may be used which has been subjected to a surface release treatment in order to improve releasability between the pattern forming layer and the mold surface. As such a mold, those treated with a silane coupling agent such as a silicone-based silane coupling agent or a fluorine-based silane coupling agent, for example, commercially available releasing agents such as OPTOOL DSX (manufactured by Daikin Industries, Ltd.) and Novec EGC-1720 (manufactured by Sumitomo 3M Ltd.) can also be suitably used.

In a case where such photoimprint lithography is carried out, it is usually preferable to carry out the lithography at a mold pressure of 10 atm or less. In a case where the mold pressure is set to 10 atm or less, the mold and the substrate film are hardly deformed and the pattern accuracy tends to improve. In addition, it is preferable from the viewpoint that the pressure unit may be small-sized since the pressure to be given to the mold may be low. Regarding the mold pressure, it is preferable to select a region where uniformity of mold transfer can be secured within the range where the residual film of the pattern forming layer in the area of mold pattern projections is reduced.

The irradiation dose of photo-irradiation in the step of irradiating the pattern forming layer with light may be sufficiently larger than the irradiation dose necessary for curing. The irradiation dose necessary for curing is appropriately determined by examining the consumption amount of unsaturated bonds of the curable composition and the tackiness of the cured film.

In the photoimprint lithography, photo-irradiation is carried out while keeping the substrate temperature generally at room temperature, in which the photo-irradiation may alternatively be conducted under heating for the purpose of enhancing the reactivity. The photo-irradiation may be carried out in vacuo, since a vacuum conditioning prior to the photo-irradiation is effective for preventing entrainment of bubbles, suppressing the reactivity from being reduced due to incorporation of oxygen, and for improving the adhesiveness between the mold and the pattern forming layer. In the pattern forming method, the degree of vacuum at the time of photo-irradiation is preferably in a range of 10⁻¹ Pa to 1 atm.

The light used for curing the pattern forming layer is not particularly limited, and examples thereof include light and radiation having a wavelength falling within a range of high-energy ionizing radiation, near ultraviolet light, far ultraviolet light, visible light, infrared light, and the like. The high-energy ionizing radiation source includes, for example, accelerators such as a Cockcroft accelerator, a Van de Graaff accelerator, a linear accelerator, a betatron, and a cyclotron. The electron beams accelerated by such an accelerator are used industrially most conveniently and economically; but any other radioisotopes and other radiations from nuclear reactors, such as γ-rays, X-rays, α-rays, neutron beams, and proton beams may also be used. Examples of the ultraviolet light source include an ultraviolet fluorescent lamp, a low-pressure mercury lamp, a high-pressure mercury lamp, an ultra-high-pressure mercury lamp, a xenon lamp, a carbon arc lamp, a solar lamp, and a light emitting diode (LED). Examples of the radiation include microwaves and extreme ultraviolet (EUV). In addition, laser light used in microfabrication of semiconductors, such as LED, semiconductor laser light, 248 nm KrF excimer laser light, and 193 nm ArF excimer laser light, can also be suitably used in the present invention. These light rays may be monochromatic light, or may also be a plurality of light rays of different wavelengths (mixed light).

Upon exposure, the exposure illuminance is preferably within a range of 1 mW/cm² to 50 mW/cm². In a case where the exposure illuminance is set to 1 mW/cm² or more, then the productivity may increase since the exposure time may be reduced; and in a case where the exposure illuminance is set to 50 mW/cm² or less, then it is preferable since the properties of a permanent film may be prevented from being degraded owing to side reactions. The exposure dose is preferably in a range of 5 mJ/cm² to 1,000 mJ/cm². In a case where the exposure dose is less than 5 mJ/cm², the exposure margin becomes narrow and the photocuring becomes insufficient so that problems such as adhesion of unreacted materials to the mold are liable to occur. On the other hand, in a case where the exposure dose is more than 1,000 mJ/cm², there is a risk of deterioration of the permanent film due to decomposition of the composition. Further, at the time of exposure, in order to prevent inhibition of radical polymerization by oxygen, an inert gas such as nitrogen or argon may be flowed to control the oxygen concentration to be less than 100 mg/L.

In the pattern forming method, after the pattern forming layer is cured through photo-irradiation, a step of further curing the cured pattern by applying heat thereto may be included as necessary. The temperature of heat for heating and curing the composition of the present invention after photo-irradiation is preferably 150° C. to 280° C. and more preferably 200° C. to 250° C. The heating time is preferably 5 to 60 minutes and more preferably 15 to 45 minutes.

The pattern to be formed may take any form. For example, there is a lattice-like mesh pattern in which a concave or convex portion is of a regular tetragon, or a honeycomb pattern in which a concave or convex portion is of a regular hexagon. A honeycomb pattern having a concave portion or convex portion of a regular hexagonal portion is particularly preferable from the viewpoint of effectively blocking penetration of oxygen into a phosphor layer with respect to a predetermined cutting form of the present invention.

“Backlight Unit”

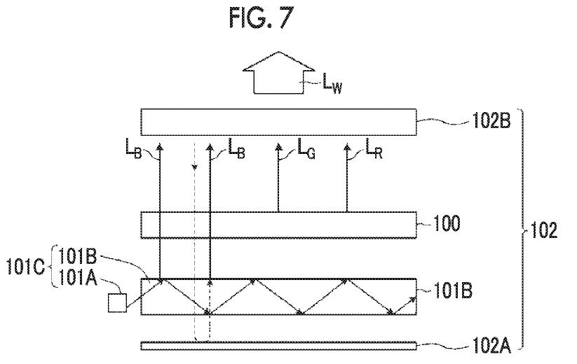

With reference to the drawings, a description will be given of a backlight unit comprising a wavelength conversion member as one embodiment of the phosphor-containing film according to the embodiment of the present invention. FIG. 7 is a schematic view showing a side edge type backlight as an example of a schematic configuration of the backlight unit.

As shown in FIG. 7, the backlight unit 102 comprises a planar light source 101C including a light source 101A that emits primary light (blue light L_{B}) and a light guide plate 101B that guides and emits primary light emitted from the light source 101A, a wavelength conversion member 100 made of the phosphor-containing film according to the embodiment of the present invention provided on the planar light source 101C, a reflective plate 102A disposed opposite to the wavelength conversion member 100 with the planar light source 101C interposed therebetween, and a retroreflective member 102B. In FIG. 11, the reflective plate 102A, the light guide plate 101B, the wavelength conversion member 100, and the retroreflective member 102B are spaced apart from one another, but this shows that those components are not optically in intimate attachment with one another, and those components may actually be laminated.

The wavelength conversion member 100 emits fluorescence by using at least a part of the primary light L_{B} emitted from the planar light source 101C as excitation light and emits the secondary light (green light L_{G} and red light L_{R}) composed of this fluorescence and the primary light L_{B} transmitted through the wavelength conversion member 100. For example, the wavelength conversion member 100 is a phosphor-containing film which is constituted such that the phosphor-containing layers including the quantum dots that emit the green light L_{G} and the quantum dots that emit the red light L_{R} upon irradiation with the blue light L_{B} are sandwiched between the first and second substrate films.

In FIG. 7, L_{B}, L_{G}, and L_{R} emitted from the wavelength conversion member 100 are incident on the retroreflective member 102B, and each incident light repeats reflection between the retroreflective member 102B and the reflective plate 102A and passes through the wavelength conversion member 100 many times. As a result, in the wavelength conversion member 100, a sufficient amount of excitation light (blue light L_{B}) is absorbed by the phosphors 31 (in this case, quantum dots) in the phosphor-containing layer 30 and a necessary amount of fluorescence (L_{G} and L_{R}) is emitted, and the white light L_{W} is embodied from the retroreflective member 102B and is emitted.

From the viewpoint of realizing high luminance and high color reproducibility, it is preferable to use, as the backlight unit, one formed into a multi-wavelength light source. For example, preferred is a backlight unit which emits blue light having a luminescence center wavelength in the wavelength range of 430 to 480 nm and having a luminescence intensity peak with a half-width of 100 nm or less, green light having a luminescence center wavelength in the wavelength range of 500 to 600 nm and having a luminescence intensity peak with a half-width of 100 nm or less, and red light having a luminescence center wavelength in the wavelength range of 600 nm to 680 nm and having a luminescence intensity peak with a half-width of 100 nm or less.

From the viewpoint of further improving luminance and color reproducibility, the wavelength range of the blue light emitted from the backlight unit is more preferably 440 nm to 460 nm.

From the same viewpoint, the wavelength range of the green light emitted from the backlight unit is preferably 520 nm to 560 nm and more preferably 520 nm to 545 nm.

In addition, from the same viewpoint, the wavelength range of the red light emitted from the backlight unit is more preferably 610 nm to 650 nm.

In addition, from the same viewpoint, all the half-widths of the respective luminescence intensities of the blue light, the green light, and the red light emitted from the backlight unit are preferably 80 nm or less, more preferably 50 nm or less, further preferably 40 nm or less, still more preferably 30 nm or less. Among them, the half-width of the luminescence intensity of the blue light is particularly preferably 25 nm or less.

In the above description, the light source 101A is, for example, a blue light emitting diode that emits blue light having a luminescence center wavelength in the wavelength range of 430 nm to 480 nm, but an ultraviolet light emitting diode that emits ultraviolet light may be used. As the light source 101A, a laser light source or the like may be used in addition to light emitting diodes. In a case where a light source that emits ultraviolet light is provided, the wavelength conversion layer (phosphor-containing layer) of the wavelength conversion member may include a phosphor that emits blue light, a phosphor that emits green light, and a phosphor that emits red light, upon irradiation with ultraviolet light.

In FIG. 7, an edge light mode backlight unit including a light guide plate, a reflective plate, and the like as constituent members has been illustrated as the configuration of the backlight unit, but the backlight unit may be a direct backlight mode backlight unit in which a plurality of light sources are disposed on a reflective plate and which comprises a diffusion plate.

A known light guide plate or diffusion plate can be used without any limitation as the light guide plate or diffusion plate.

In addition, the reflective plate 102A is not particularly limited, and known reflective plates can be used, which are described in JP3416302B, JP3363565B, JP4091978B, JP3448626B, and the like, the contents of which are incorporated by reference herein in their entirety.

The retroreflective member 102B may be configured of a known diffusion plate or a known diffusion sheet, a known prism sheet (for example, BEF series manufactured by Sumitomo 3M Limited), a known light guide device, and the like. The configuration of the retroreflective member 102B is described in JP3416302B, JP3363565B, JP4091978B, JP3448626B, and the like, the contents of which are incorporated by reference herein in their entirety.

The backlight unit according to the embodiment of the present invention can be suitably used as a backlight for a liquid crystal display.

### EXAMPLES

Hereinafter, the present invention will be more specifically described with reference to Examples. The materials, use amounts, proportions, treatment contents, treatment procedures, and the like shown in the following Examples can be appropriately modified without departing from the spirit of the present invention. Therefore, the scope of the present invention should not be construed as being limited to the following specific Examples.

### Example 1

(Preparation of Substrate Film 10)

Using a polyethylene terephthalate (PET) film (manufactured by Toyobo Co., Ltd., trade name “COSMOSHINE (registered trademark) A4300”, thickness: 50 μm) as the support film 11, an organic layer and an inorganic layer were sequentially formed on one side of the support by the following procedure.

(Formation of Organic Layer)

Trimethylolpropane triacrylate (product name “TMPTA”, manufactured by Daicel-Allnex Ltd.) and a photopolymerization initiator (trade name “ESACURE (registered trademark) KTO46”, manufactured by Lamberti S.p.A.) were prepared and weighed in a mass ratio of 95:5, and these were dissolved in methyl ethyl ketone to prepare a coating liquid having a solid content concentration of 15%. This coating liquid was applied on a PET film in a roll to roll process using a die coater and passed through a drying zone at 50° C. for 3 minutes. Thereafter, the coating film was irradiated with ultraviolet light under a nitrogen atmosphere (cumulative irradiation dose: about 600 mJ/cm²), cured by ultraviolet light, and wound up. The thickness of the organic layer formed on the support was 1 μm.

(Formation of Inorganic Layer)

Next, an inorganic layer (silicon nitride layer) was formed on the surface of the organic layer by using a roll-to-roll CVD apparatus. Silane gas (flow rate: 160 sccm), ammonia gas (flow rate: 370 sccm), hydrogen gas (flow rate: 590 sccm), and nitrogen gas (flow rate: 240 sccm) were used as raw material gases. As a power source, a high-frequency power source with a frequency of 13.56 MHz was used. The film forming pressure was 40 Pa, and the film thickness reached was 50 nm. In this manner, a substrate film 10 was prepared in which an inorganic layer was laminated on the surface of the organic layer formed on the support film 11.

(Preparation of Substrate Film with Light Scattering Layer)

A protective film (PAC2-30-T, manufactured by Sun A. Kaken Co., Ltd.) was bonded to protect the surface of the inorganic layer of the substrate film 10, and then a light scattering layer was formed on the back surface of the PET film by the following method.

(Preparation of polymerizable composition for forming light scattering layer) As light scattering particles, 150 g of silicone resin particles (TOSPEARL 120, manufactured by Momentive Performance Materials Inc., average particle size: 2.0 μm) and 40 g of polymethyl methacrylate (PMMA) particles (TECHPOLYMER, manufactured by Sekisui Chemical Co., Ltd., average particle size: 8 μm) were first stirred and dispersed in 550 g of methyl isobutyl ketone (MIBK) for about 1 hour to obtain a dispersion liquid.

To the resulting dispersion liquid were added 50 g of an acrylate-based compound (VISCOAT 700HV, manufactured by Osaka Organic Chemical Industry Co., Ltd.) and 40 g of an acrylate-based compound (8BR500, manufactured by Taisei Fine Chemical Co., Ltd.), followed by further stirring. 1.5 g of a photopolymerization initiator (IRGACURE (registered trademark) 819, manufactured by BASF Corporation) and 0.5 g of a fluorine-based surfactant (FC4430, manufactured by 3M Ltd.) were further added to prepare a coating liquid (a polymerizable composition for forming a light scattering layer).

(Coating and Curing of Polymerizable Composition for Forming Light Scattering Layer)

Delivery was set so that the surface of the PET film of the substrate film 10 was the coating surface, and the coating liquid was transported to a die coater and then coated. The wet coating amount was adjusted with a liquid feed pump and the coating was carried out at a coating amount of 25 cc/m² (the thickness was adjusted so as to be about 12 μm with the dried film). After passing through a drying zone at 60° C. for 3 minutes, the film was wound around a backup roll adjusted at 30° C., cured with ultraviolet light of 600 mJ/cm², and then taken up. In this manner, a substrate film with a light scattering layer was obtained as a laminated film of the substrate film 10 and the light scattering layer.

(Preparation of Coating Liquid for Forming Fluorescent Region and Third Layer Coating Liquid)

The following polymerizable composition 1 was prepared, filtered through a polypropylene filter having a pore size of 0.2 μm, and then dried under reduced pressure for 30 minutes to obtain a coating liquid for forming a first fluorescent region.

The following polymerizable composition 2 was prepared, filtered through a polypropylene filter having a pore size of 0.2 μm, and then dried under reduced pressure for 30 minutes to obtain a coating liquid for forming a second fluorescent region.

AQUAMICA NP140 (manufactured by AZ Electronic Materials plc) was suitably diluted with xylene to obtain a third layer coating liquid.

—Polymerizable Composition 1—

| | | |
|---|---|---|
| Toluene dispersion liquid (emission maximum: | 20.0 | parts by mass |
| 520 nm) of quantum dot 1 | | |
| Dicyclopentanyl acrylate (FA-513AS, | 78.4 | parts by mass |
| manufactured by Hitachi Chemical Co., Ltd.) | | |
| Tricyclodecane dimethanol diacrylate (A-DCP, | 20.0 | parts by mass |
| manufactured by Shin-Nakamura Chemical Co., | | |
| Ltd.) | | |
| Photopolymerization initiator (IRGACURE TPO, | 0.2 | parts by mass |
| manufactured by BASF Corporation) | | |
| Silane coupling agent (KBM-5103, | 2.0 | parts by mass |
| manufactured by Shin-Etsu Chemical Co., Ltd.) | | |
| Antioxidant (trioctyl phosphite, | 0.4 | parts by mass |
| manufactured by Tokyo Chemical Industry Co., | | |
| Ltd.) | | |

—Polymerizable Composition 2—

| | | |
|---|---|---|
| Toluene dispersion liquid (emission maximum: | 2 | parts by mass |
| 620 nm) of quantum dot 2 | | |
| Dicyclopentanyl acrylate (FA-513AS, | 78.4 | parts by mass |
| manufactured by Hitachi Chemical Co., Ltd.) | | |
| Tricyclodecane dimethanol diacrylate (A-DCP, | 20.0 | parts by mass |
| manufactured by Shin-Nakamura Chemical Co., | | |
| Ltd.) | | |
| Photopolymerization initator (IRGACURE TPO, | 0.2 | parts by mass |
| manufactured by BASF Corporation) | | |
| Silane coupling agent (KBM-5103, | 2.0 | parts by mass |
| manufactured by Shin-Etsu Chemical Co., Ltd.) | | |
| Antioxidant (trioctyl phosphite, | 0.4 | parts by mass |
| manufactured by Tokyo Chemical Industry Co., | | |
| Ltd.) | | |

The quantum dot concentration in the toluene dispersion liquid of quantum dot 1 and quantum dot 2 is 3% by mass.

Quantum dot 1 (CZ520-100, manufactured by NN-labs, LLC.) is a core/shell type quantum dot having a core of CdSe and a shell of ZnS, and has a luminescence center wavelength of 520 nm and a half-width of 30 nm.

Octadecylamine as a ligand is coordinated to quantum dot 1.

Quantum dot 2 (INP620-100, manufactured by NN-labs, LLC.) is a core/shell type quantum dot having a core of InP and a shell of ZnS, and has a luminescence center wavelength of 620 nm and a half-width of 40 nm.

Oleylamine and a phosphine derivative as ligands are coordinated to quantum dot 2.

(Preparation of Phosphor-Containing Film)

—Formation of First Fluorescent Region—

The coating liquid for forming a first fluorescent region was applied onto the first substrate film 10 using a roll-to-roll type production apparatus, and the concave portion was transferred, followed by photocuring to form a first fluorescent region having a plurality of concave portions. Here, the concave portion had a square shape of 250 μm×250 μm, a lattice-like pattern, a depth of 40 μm, and a width of 50 μm. For photocuring, the resin layer was cured by irradiation with ultraviolet light at a dose of 2000 mJ/cm² from the first film side using an air-cooled metal halide lamp (manufactured by Eye Graphics Co., Ltd.) at 160 W/cm.

—Formation of Third Layer—

The third layer coating liquid was applied on the first fluorescent region with a die coater to form a coating film having a thickness of 50 μm which was then allowed to pass through a heating zone at 100° C. for 3 minutes to be dried and cured, whereby the third layer was formed into a film having a thickness of 1 μm.

—Formation of Second Fluorescent Region and Adhesion of Second Substrate Film—

The coating liquid for forming a second fluorescent region was applied onto the first substrate film, on which the first fluorescent region having a plurality of concave portions and the third layer were formed, by using a roll-to-roll type production apparatus to fill the coating liquid for forming a second fluorescent region in the concave portion, the substrate film with a light scattering layer was adhered as the second substrate film, and then the coating liquid for forming a second fluorescent region was photocured to form a phosphor-containing layer having a first fluorescent region having a concavo-convex shape, a second fluorescent region having a concavo-convex shape, and a third layer, thus preparing a phosphor-containing film. For photocuring, the fluorescent region was cured by irradiation with ultraviolet light at a dose of 2000 mJ/cm² from the first substrate film side using an air-cooled metal halide lamp (manufactured by Eye Graphics Co., Ltd.) at 160 W/cm and further heated at 80° C. for 10 minutes. The thickness of the phosphor-containing layer of the resulting phosphor-containing film was 40 μm.

In addition, the phosphor-containing film of Example 1 was cut with a microtome to form a cross section which was then observed with a scanning electron microscope.

As a result, t1 was 400 μm, t2 was 400 μm, t3 was 1 μm, d1 and d2 were each 0.5 μm, h was 37 μm, and H was 40 μm.

### Example 2

A phosphor-containing film was prepared in the same manner as in Example 1, except that the phosphor contained in the coating liquid for forming a first fluorescent region and the coating liquid for forming a second fluorescent region was a mixture of quantum dots 1 and 2.

### Comparative Example 1

A phosphor-containing film was prepared in the same manner as in Example 2, except that the third layer was not formed.

[Evaluation]

(Measurement of Luminance)

A backlight unit was taken out by disassembling a commercially available tablet terminal comprising a blue light source in the backlight unit (trade name “Kindle (registered trademark) Fire HDX 7”, manufactured by Amazon, hereinafter sometimes simply referred to as Kindle Fire HDX 7). Instead of Quantum Dot Enhancement Film (QDEF), the phosphor-containing film of Examples or Comparative Examples cut into a rectangle was incorporated into the backlight unit. In this manner, a liquid crystal display was prepared. The prepared liquid crystal display was turned on so that the whole surface became white display and the luminance was measured with a luminance meter (trade name “SR3”, manufactured by Topcon Corporation) installed at a position 520 mm in a direction perpendicular to the plane of the light guide plate.

(Evaluation of Ingress Distance)

The sample after the light durability test was observed under an optical microscope to evaluate the ingress distance (distance at which change in chromaticity or reduction in luminance can be confirmed by visual inspection) 1 mm.

—Evaluation Standards—

A: 1≤0.5

B: 0.5≤1≤1.5

C: 1.5<1

(Thermal Durability of Luminance)

The prepared phosphor-containing film was heated at 85° C. for 1000 hours using a precision thermostat DF411 (manufactured by Yamato Scientific Co., Ltd.). Thereafter, the film was incorporated into Kindle Fire HDX 7 in the same manner as above, and the luminance was measured.

The thermal durability of luminance was evaluated based on the following evaluation standards.

<Evaluation Standards>

A: Reduction in luminance after heating is less than 5%

B: Reduction in luminance after heating is 5% or more and less than 10%

C: Reduction in luminance after heating is 10% or more and less than 15%

D: Reduction in luminance after heating is 15% or more

The evaluation results of Examples 1 and 2 and Comparative Example 1 are shown below.

TABLE 1

| | First resin | Second | Third layer | | Luminance durability evaluation | |
|---|---|---|---|---|---|---|
| | layer | resin layer | | Thickness | Ingress distance | Thermal |
| | Phosphor | Phosphor | Material | μm | 1 mm | durability Y_{D} |
| Example 1 | CdSe/ZnS | InP/ZnS | AQUAMICA | 1 | A | A |
| | | | NP140 | | | |
| Example 2 | CdSe/ZnS | CdSe/ZnS | AQUAMICA | 1 | A | B |
| | InP/ZnS | InP/ZnS | NP140 | | | |
| Comparative | CdSe/ZnS | InP/ZnS | — | — | C | D |
| Example 1 | | | | | | |

From the results in Table 1, it can be seen that Examples of the present invention exhibit a smaller ingress distance and higher thermal durability than Comparative Examples.

From the above results, the effects of the present invention are obvious.

Explanation of References
1: phosphor-containing film
10, 20: substrate film
11, 21: support film
12, 22: barrier layer
30: phosphor-containing layer
31: phosphor of first fluorescent region
32: coating liquid for forming first fluorescent region
33: binder of first fluorescent region
35: first fluorescent region
36: phosphor of second fluorescent region
37: coating liquid for forming second fluorescent region
38: second fluorescent region
39: binder of second fluorescent region
40: third layer
100: wavelength conversion member
101A: light source
101B: light guide plate
101C: planar light source
102: backlight unit
102A: reflective plate
102B: retroreflective member

What is claimed is:

1. A phosphor-containing film comprising: between two facing substrate films,
a first resin layer having a first concavo-convex shape on one main surface;
a second resin layer having a second concavo-convex shape on the other main surface facing the one main surface of the first resin layer that has the first concavo-convex shape; and
a third layer that follows the first concavo-convex shape and the second concavo-convex shape between the first resin layer and the second resin layer,
wherein the two substrate films are each a barrier film in which a barrier layer is laminated on a support film,
the first resin layer and the second resin layer contain phosphors, and
the third layer is formed of an inorganic material.

2. The phosphor-containing film according to claim 1, wherein the first resin layer and the second resin layer each contain different phosphors.

3. The phosphor-containing film according to claim 1,
wherein the first resin layer and the second resin layer each has a depth h of a concave portion of 10 μm or more and 150 μm or less, and
the third layer has a thickness t3 of 0.1 μm or more and 10 μm or less.

4. The phosphor-containing film according to claim 2,
wherein the first resin layer and the second resin layer each has a depth h of a concave portion of 10 μm or more and 150 μm or less, and
the third layer has a thickness t3 of 0.1 μm or more and 10 μm or less.

5. The phosphor-containing film according to claim 1, wherein the third layer has an oxygen permeability of 10 cc/(m²·day·atm) or less.

6. The phosphor-containing film according to claim 4, wherein the third layer has an oxygen permeability of 10 cc/(m²·day·atm) or less.

7. The phosphor-containing film according to claim 1, wherein the two substrate films each have an oxygen permeability of 1 cc/(m²·day·atm) or less.

8. The phosphor-containing film according to claim 6, wherein the two substrate films each have an oxygen permeability of 1 cc/(m²·day·atm) or less.

9. A backlight unit comprising:
the phosphor-containing film according to claim 1 as a wavelength conversion member.

10. A backlight unit comprising:
the phosphor-containing film according to claim 8 as a wavelength conversion member.
